(19) United States
(12) Patent Application Publication
(10) Pub. No.: US 2026/0195731 A1
(43) Pub. Date: Jul. 9, 2026

(54) MOBILE KIOSK SELF-CHECKOUT SYSTEM

(71) Applicant: TOSHIBA GLOBAL COMMERCE SOLUTIONS, INC., Durham, NC (US)

(72) Inventors: Yevgeni Tsirulnik, Durham, NC (US); Evgeny Shevtsov, Durham, NC (US); Kirk Alexander Goldman, Durham, NC (US); Naresh Keswani, Durham, NC (US); Yeshai Bouskila, Durham, NC (US); Brad Johnson, Durham, NC (US); Shruti Gandhi, Durham, NC (US)

(73) Assignee: TOSHIBA GLOBAL COMMERCE SOLUTIONS, INC., Durham, NC (US)

(21) Appl. No.: 19/304,354

(22) Filed: Aug. 19, 2025

Related U.S. Application Data
(63) Continuation of application No. 19/176,048, filed on Apr. 10, 2025.
(60) Provisional application No. 63/743,359, filed on Jan. 9, 2025.

(51) Int. Cl. G06Q 20/18; G06Q 20/20; G06V 10/75; G06V 20/52

(52) U.S. Cl. CPC G06Q 20/18; G06Q 20/202; G06Q 20/208; G06V 10/75; G06V 20/52

(57) ABSTRACT

A mobile kiosk self-checkout (SCO) system is a fully autonomous, AI-powered mobile checkout kiosk that uses embedded cameras, computer vision, and edge AI to detect shoppers with small baskets or few items and invites them to bypass checkout lines through a voice-driven, frictionless interaction. The mobile kiosk self-checkout selects a shopper to approach, where the shopper is waiting to checkout at a checkout system different from the mobile self-checkout system. The mobile kiosk self-checkout includes motorized wheels and navigates to the selected shopper. A point of sale system on the mobile kiosk self-checkout is configured to checkout the selected shopper in response to the mobile self-checkout system navigating to the selected shopper and the selected shopper agreeing to checkout at the mobile self-checkout system.

### CROSS REFERENCES TO RELATED APPLICATIONS

The present application is a continuation of U.S. Application No. 19/176,048, filed April 10, 2025, which in turn claims the benefit of U.S. Provisional Application No. 63/743,359, filed on January 9, 2025, which are hereby incorporated by reference in their entireties.

### BACKGROUND

Buyers are currently offered the option to purchase items at self-service kiosks. Self-service kiosks have become desirable to both buyers and retailers. For buyers, the kiosks offer reduced wait times as compared to using a cashier lane. Retailers also benefit from reduced labor costs, as one member of staff can monitor several self-service counters. During a checkout transaction, a buyer can scan product barcodes for each product and can place them on a platform to be weighed and/or monitored during the transaction.

Self-service kiosks are currently limited to set locations within brick and mortar locations limiting the buyers and locations that they can service.

### BRIEF DESCRIPTION OF THE DRAWINGS

FIG. 1A ilustrates a perspective view of an exemplary mobile kiosk self-checkout (“SCO”) system according to one or more embodiments of the present disclosure.

FIG. 1B illustrates a perspective partially-transparent view of the mobile checkout kiosk exemplary mobile self-checkout system of FIG. 1 according to one or more embodiments of the present disclosure.

FIG. 1C illustrates a perspective view of an exemplary mobile checkout kiosk self-checkout system of FIG. 1A with the cover removed and with an exemplary self-checkout SCO terminal according to one or more embodiments of the present disclosure.

FIG. 1D illustrates a front perspective view of an exemplary mobile checkout kiosk self-checkout system without the self-checkout SCO terminal and with a portion of the cover removed according to one or more embodiments of the present disclosure.

FIG. 1E illustrates a rear perspective view of an exemplary mobile checkout kiosk self-checkout system with a portion of the cover removed according to one or more embodiments of the present disclosure.

FIG. 1F illustrates a front perspective view of an exemplary mobile checkout kiosk self-checkout system without the self-checkout SCO terminal and with a portion of the cover removed according to one or more embodiments of the present disclosure.

FIG. 1G illustrates a rear view of an exemplary mobile checkout kiosk self-checkout system according to one or more embodiments of the present disclosure.

FIG. 1H illustrates a side view of an exemplary mobile checkout kiosk self-checkout system with a portion of the cover removed and without the self-checkout SCO terminal according to one or more embodiments of the present disclosure.

FIG. 1I illustrates a front perspective view of an exemplary mobile checkout kiosk self-checkout system with the self-checkout SCO terminal and with a portion of the cover removed according to one or more embodiments of the present disclosure.

FIG. 1J illustrates a rear perspective view of an exemplary mobile checkout kiosk self-checkout system with the self-checkout SCO terminal and with a portion of the cover removed according to one or more embodiments of the present disclosure.

FIG. 2 illustrates a perspective view of an exemplary self-checkout system of the SCO according to one or more embodiments of the present disclosure.

FIG. 3 illustrates a perspective view of another exemplary self-checkout system of the SCO according to one or more embodiments of the present disclosure.

FIG. 4 illustrates a schematic view of the self-checkout system of FIG. 2, according to one or more embodiments of the present disclosure.

FIGS. 5 and 6 illustrate schematic views of mobile self-checkout systems, according to other embodiments of the present disclosure.

FIG. 7 illustrates a schematic view of the self-checkout system of FIG. 5/6, according to one or more embodiments of the present disclosure.

FIG. 8 illustrates a method of operation the self-checkout system of FIG. 5/6, according to one or more embodiments of the present disclosure.

FIGS. 9A and 9B illustrate schematic views of the self-checkout system of FIG. 5/6 for shopper determination and queue bypassing, according to one or more embodiments of the present disclosure.

FIG. 10 illustrates a perspective view of an exemplary mobile self-checkout system according to one or more embodiments of the present disclosure.

FIG. 11 illustrates a diagram showing autonomous navigation of the mobile self-checkout system of FIG. 10, according to one or more embodiments of the present disclosure.

FIG. 12 illustrates a diagram illustrating a user checking out of the mobile self-checkout system of FIG. 10, according to one or more embodiments of the present disclosure.

FIG. 13 illustrates a method of operation the mobile self-checkout system of FIG. 10, according to one or more embodiments of the present disclosure.

FIG. 14 illustrates a schematic diagram of the self-checkout system of FIG. 10, according to one or more embodiments of the present disclosure.

### DETAILED DESCRIPTION

Prior to the present application, self-checkout counters are required to be in brick-and-mortar locations and were not mobile. These self-checkout counters had sensors and other components that needed a stable environment in various aspects, such as a flat foundation, consistent normal environmental conditions (e.g., dry, room temperature, etc.), etc.

Embodiments disclosed herein are directed to a mobile kiosk mobile self-checkout (“SCO”) system that address one or more of the challenges noted above.

Generally, and as will be described in more depth herein, the mobile checkout kiosk self-checkout system includes a SCO comprising: one or more cameras; and a processor to determine an identity of one or more items within a predefined zone based at least in part on the one or more images captured by the one or more cameras. The SCO self-checkout system also includes a cover around the SCO, where the cover has a portion that is configured to expose the SCO to a user so the user can use the SCO. The SCO may have smart shelves, be configured to manage lighting for the SCO and protection of the SCO from environmental conditions, and have other features which allow for it to be a mobile self-checkout counter system/store.

The below description describes (1) exemplary components of the mobile system which allow for the system to be a mobile store, and (2) exemplary components and workings of the SCO.

### I. Mobile Kiosk (“SCO”) System

Embodiments of the present application are directed to a mobile checkout kiosk self-checkout system 10 that allows the mobile checkout kiosk self-checkout system 10 to be in effect a mobile store as it may come pre-stocked with items prior to arriving at the mobile location. There were various challenges in coming up with this design and the below components detail various embodiments which allow an SCO to become a mobile store.

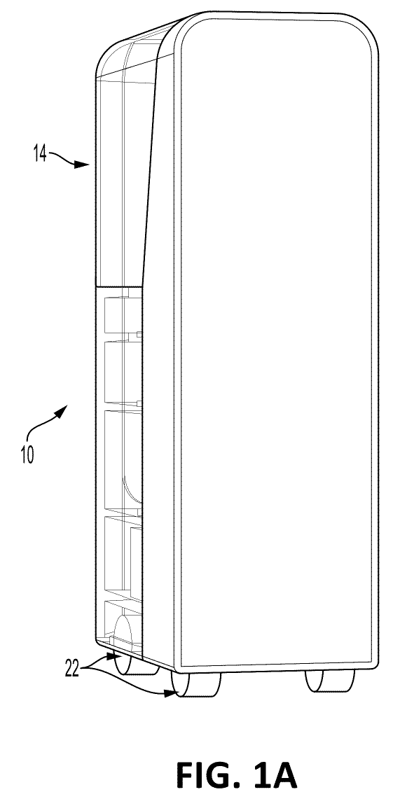

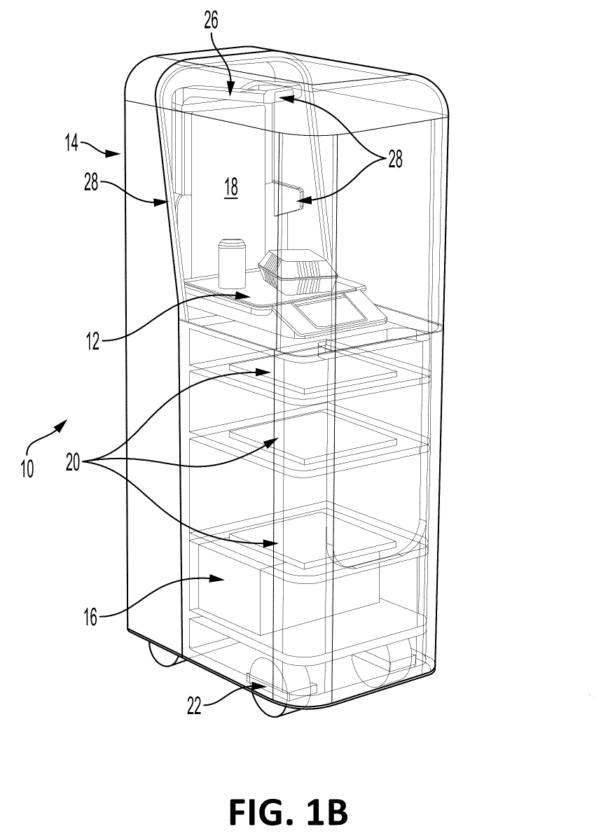

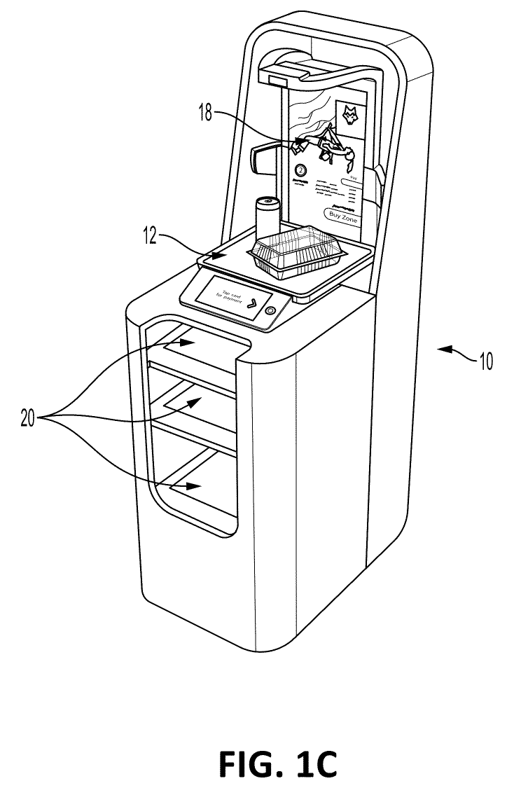

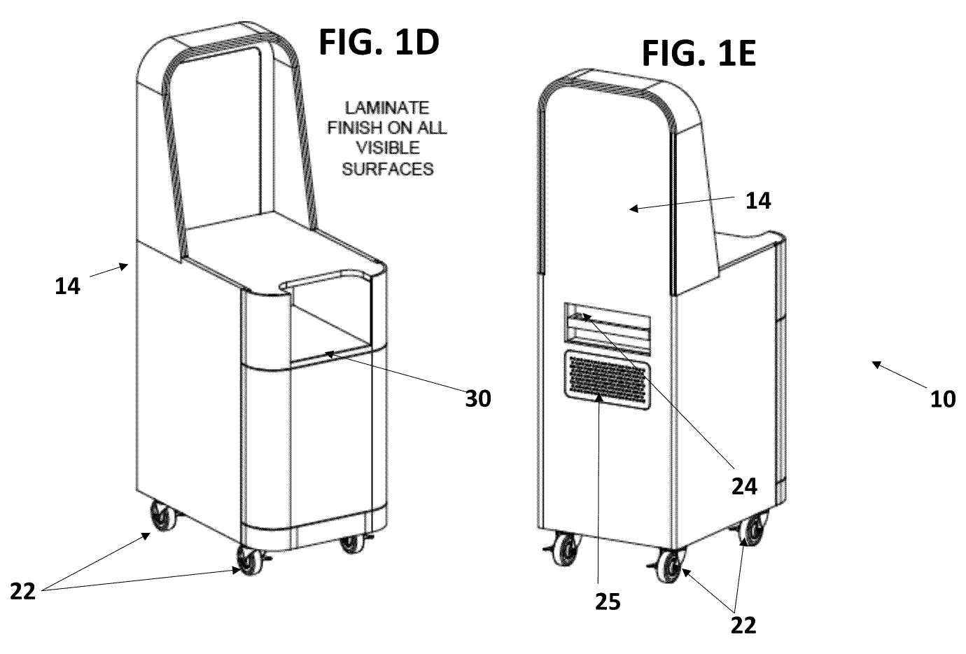

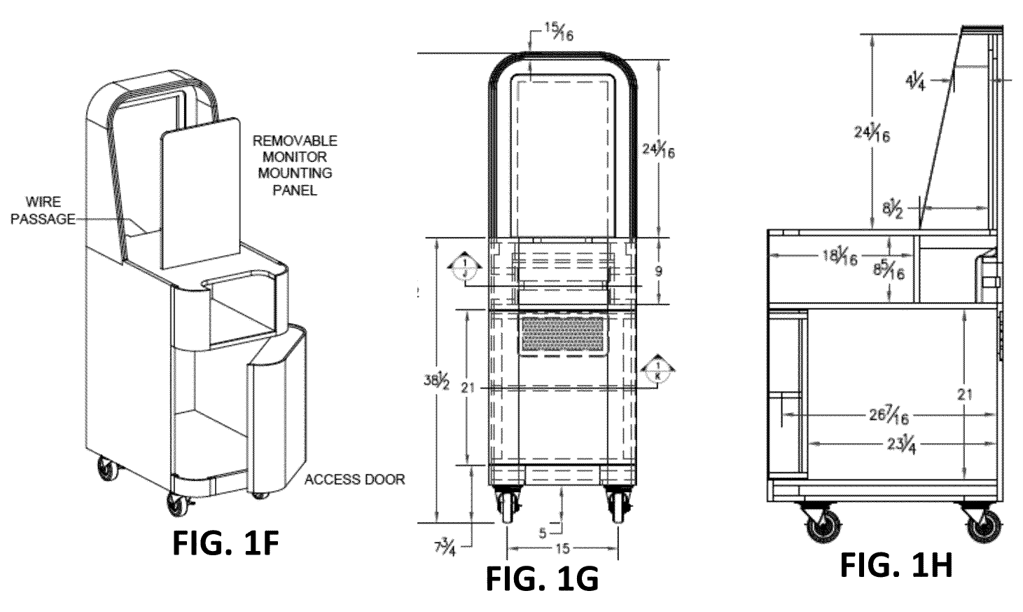

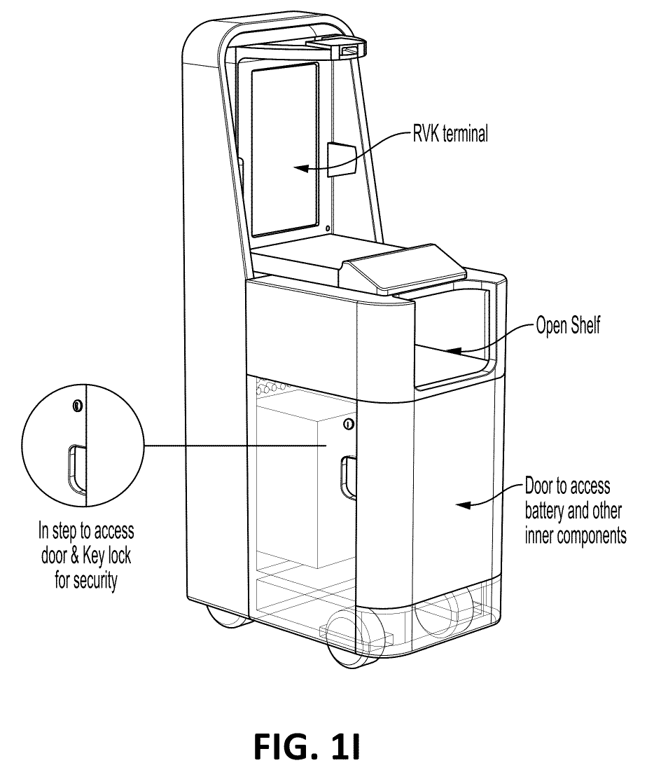

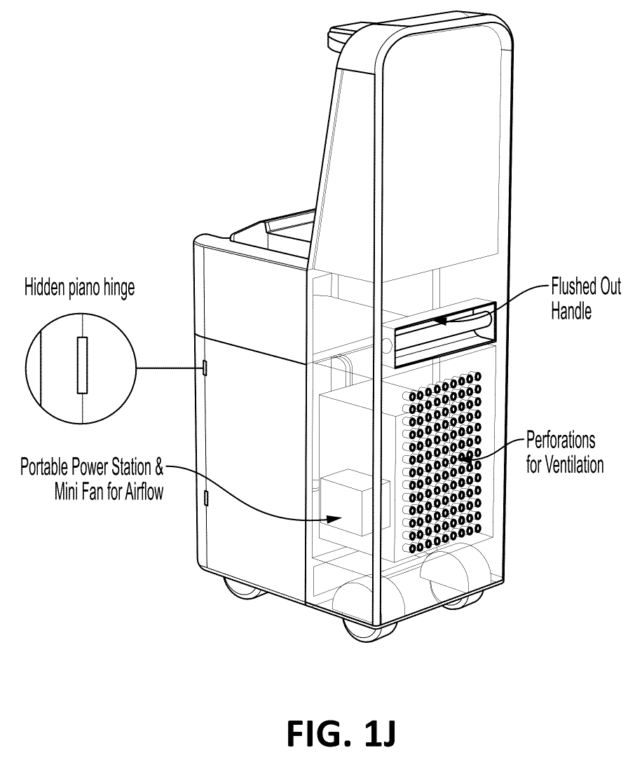

With reference to FIGS. 1A-1J, various embodiments of a mobile checkout kiosk system 10 are provided. As shown in some embodiments, the mobile checkout kiosk system 10 includes an SCO 12 with a protective box/cover/case 14 powered by a power source 16 (e.g., a battery) along with networking capabilities 18 (e.g., short range wireless networking, long range/cellular wireless networking, Internet connectivity, etc.) according to some embodiments. The SCO self-checkout system 10 also includes other features such as smart shelves 20, wheels 22, special software modules, and/or other features according to various embodiments. These and other exemplary components are discussed below.

As mentioned above and as shown in FIGS. 1A-1J the mobile checkout kiosk system 10 has an SCO 12 which is discussed later herein under the header “SCO”.

Next, the mobile checkout kiosk system 10 includes a cover 14, which is illustrated in: FIGS. 1A and 1B (fully encasing the SCO 12 according to one embodiment), FIG. 1C (showing the system 10 without the SCO 12 according to one embodiment), and FIG. 1C (with a portion of the cover 14 removed when the system 10 is in use with customers as a mobile store according to one embodiment).

The cover 14 may be integrated with or structurally connected to the SCO 12, may be removable relative to the SCO 12, or could otherwise be moveable (e.g., slide, spin around, etc.) relative to the SCO 12. The cover 14 may be attached to a roll bar or other supporting structure (not shown) configured to provide sufficient structural support to protect the SCO 12 from external hazards, such as falling items, accidental hitting/bumping from other objects, etc.

The cover 14 may have structure that provides a shell that attaches directly to the SCO 12. In this regard, the cover 14 could be attached to a sturdy frame or housing (made of metal or other structurally sound material) that surrounds electronics of the SCO 12 so that the cover 14 (which is a material such as metal, fiberglass, or the like) covers the frame/shell as a housing for the frame/shell. The cover 14 and shell/frame may be attached directly to the SCO 12 using fasteners or the like. In one embodiment, the SCO 12 may not be attached directly to the cover 14 and shell/frame and instead shock absorbers or other devices/materials may be disposed therebetween.

The cover 14 may be smart in that the cover may automatically close in response to determining that inclement weather is imminent or if an object is falling on the system. For example, the cover 14 may enclose the SCO 12 to shield the SCO 12 from a triggering event (e.g., falling objects, rain, etc.). in response to the system 10 detecting or being informed of the triggering event.

The cover 14 not only protects the SCO 12 but is also a part of the shipping/transport of the SCO 12. In this regard, the cover 14 connects with the rollbar and cart tablet top. This form factor also acts as the signage with possible lane number/integrate existing transaction awareness light (“TAL”) function. The portion of the cover 14 that is created with a hoop or roll bar at the top of the system 10 is also intended to help block/control the light so the cameras function properly as explained more below.

The cover 14 may be made of any sturdy material, such as metal, fiberglass, injected foam, or other material to protect the SCO 12 from bumping into other objects or crashing or falling onto the ground, wall or floor. The cover 14 may fully enclose the SCO 12 as shown in FIG. 1A and 1B (which can be useful during transporting the system 10 and when the SCO 12 is not in use) and also have an area or portion which can be removed to allow a user to access the SCO 12. This is shown in FIGS. 1C and 1D where the removable section of the cover 14 has been removed allowing a user to access the SCO 12, shelves 20, etc.

When the removable section of the cover 14 has been removed, as shown in FIGS. 1C-1J, the cover 14 may be such that the electronic components (e.g., cameras, screens, shelves, payment mechanism, sensors, etc.) of the SCO are covered to protect the electronic components. For example, the cover 14 may extend over the biometric sensor when the removable section of the cover 14 has been removed.

Between the cover 14 and the SCO 12 (and/or other electronic components of the system 10) may be a vibration/shock absorption material or component so that vibrations and shocks on the system 10 may not be received (or greatly reduced) for the SCO 12. For example, there may be an injected foam component between the cover 14 and the SCO 12. Alternatively or additionally, there could be a shock absorber (e.g., shock absorbing spring) between the cover 14 and the SCO 12.

When the system 10 is transported, the SCO 12 and/or one or more electronic components could receive shock and/or vibration which could cause one or more of these components to not function optimally. For example, a camera may lose its calibration due to excessive vibrations from moving the system 10 from one location to another (e.g., moving the system from a brick and mortar store to a remote field for a concert). In these type scenarios, the system 10 could detect that the vibration or shock to the system 10, such as to the SCO 12 and/or one or more electronic components, has occurred greater than a predefined threshold. As such, when such predefined threshold has been detected to have been exceeded, the system 10 may perform one or more actions, such as sending a message to alert about the excessive vibration/shock, perform automatic corrective procedures, etc. For example, the message could be to request a technician or other person/device to come to the system and fix the issue (e.g., perform re-calibration). As another example, corrective procedures could be remotely performed over a network or the system 10 could itself diagnose the issue and automatically perform corrective procedures.

Next, the system 10 includes a power source, such as a battery 16 as shown in the embodiments of FIGS. 1B, 1C, 1I, and 1J. The battery 16 may be a heavy duty battery and could have a 12 hour life cycle. The battery 16 is configured to power any of the electronic components of the system 10, including the SCO 12 (e.g., the shelves 20, cameras, sensors, etc.), the wheels 22, any other cameras for the system, any motors or activators, etc. The battery 16 may be physically attached to the cover 14 or a frame to be secured to the system 10. As shown in FIG. 1B, the battery 16 may be positioned at the bottom of the system 10 to leave the upper portions of the system 10 accessible to users.

Next, the system 10 includes at least one networking device(s) 18 so that the system 10 will have wide area network (WAN) (e.g., internet) or local area network (LAN) connectivity. This can include a mobile hotspot, cellular, WiFi, and the like using devices such as a modem, a cellular antenna, and/or a port to allow the SCO 12 to be plugged in using a networking cable, etc. For example, the system 10 could have an antenna and software to connect the SCO 12 to a network using cellular connection. This allows the system 10 to be connected to the Internet or other network regardless of where the system 10 is located, making this system 10 not limited to be at any specific location.

It should be understood that the networking devices 18 do not need to be limited to any particular location on the system 10. For example, the networking devices 18 may be located between the SCO 12 and the cover 14, as shown in FIG. 1B. In other embodiments, the networking devices 18 may be placed within the cover 14 itself, or the networking devices 18 may be placed within the cover 14 itself or as a part of the SCO 12.

Next, the SCO 12 may include smart shelves 20. There may be any number of shelves 20, such as one shelf area 30 shown in FIG. 1D or many smart shelves 20 shown in FIGS. 1B and 1C. The shelves 20 each include smart pad which are each configured to communicate with the processor of the SCO 12. The smart pads capture item information through the use of computer vision as well as transmitting the captured item information to the SCO 12 for transaction processing. Once a user places the item on the smart pad, computer vision is activated, as well as sensors that capture weight information, that information is then transmitted to the SCO 14 which in turn generates a graphical element representing the item in the extended smart pad.

The shelves 20 each may include various sensors to detect items thereon, such as weigh sensors. In this regard, one or more items could be placed on each shelf 20 so that when the item is removed, the shelf 20 would recognize that the product on the shelf was selected when the customer removes such product from the shelf. Each shelf 20 would communicate its sensor data in real time to the SCO processor which would then communicate this information to an SCO interface. Thus, when a user removes items from the shelves 20, the SCO 10 understands that the user is selecting those selected items for purchase and indicates the same on the SCO interface.

As mentioned above, the shelves 20 have sensors which may be susceptible to vibration/shock and thus, may need to be recalibrated, repaired, or reset in the event that there are excess vibrations/shocks or there are other issues (e.g., weather, damage, etc.).

As shown in FIGS. 1B-1J, the shelves 20 may be located directly under the main SCO unit and there is a closable opening in the cover 14 to access each shelf. For example, in FIGS. 1A and 1B, the cover 14 is shown as covering the shelves 20 but in FIG. 1C, a portion of the cover 14 is shown as having been removed allowing for the shelves 20 to be accessible for customers.

It is noted that the shelves may be positioned so that the main SCO unit is located above the shelves 20 which effectively provides a cover above the shelves 20. In this regard, the system 10 is orientated in a vertical stacking orientation.

The system 10 is configured to be weather and environmental agnostic. For example, as discussed above, the cameras for the SCO 12 may be fully covered or partially covered by the cover 14 to shield the cameras from weather (e.g., rain, dew, etc.) to not only protect the cameras but to ensure the camera lens is not covered with moisture which would affect operation of the cameras.

Also, the system 10 may be employed with heaters, cooling devices, and the like. For example, a heater may be employed to heat any electronics in cold weather so that the temperature of the electronics does not go below a predefined threshold (so the electronics operates within proper specifications) and/or with colling devices to cool the electronics in hot weather or when the electronics are exposed to the suns rays or any other items which may heat the electronics. Such heaters or cooling devices may be placed within the cover 14 or in any other location within the system 10.

The system 10 may have a thermometer to measure the temperature of the system 10 or one or more electronic components. This thermometer is connected to the SCO 12 to report the temperature which could then automatically activate the corrective actions (e.g., heating or cooling based on predefined thresholds) or report back to a central location over a network for others or other devices to monitor the temperature of the system 10 or one or more devices of the SCO 12. Electronics that could be heated or cooled could be the battery 16, any of the cameras, the payment mechanism, the display, the SCO processor, any sensor, any motor or activator, the networking devices, etc.

The system 10 may also include wheels 22 to move the system 10. The wheels may be large wheels that are configured to absorb shock or bumps to reduce vibration or shock to the components in the system 10. Each of the wheels 22 also could be locked in place when the system 10 is at its final destination. Moreover, the wheels or another portion under (or part of) the cover 14 may have individual adjustments that can make the system 10 level in the event that the ground or floor where the system 10 is transported to is uneven or otherwise causes the system 10 not be level.

There may be any number of wheels. While the figures show there are four wheels on each corner of the bottom of the system 10, there may be additional wheels or only two wheels.

The system 10 may further include a handle 24 as shown in FIG. 1E and 1J. The handle 24 is connected to the shell/frame at a portion where the cover 14 exposes the handle 24. In some embodiments, the handle 24 may be outside of the cover 14 if the cover 14 full encapsulates the SCO 12. The handle 24 is configured to coordinate with the wheels 22 so as to easily move the system 10 so as to minimize vibration/shock and/or to minimize tilt to the SCO 12. For example, the handle 24 would be located at a position closer to the wheels 22 than the top of the system 10 so that the tilt would be minimized.

Next, the system 10 may include perforations for ventilation as shown in FIGS. 1E, 1G and 1J. The perforations maybe in the case 14 at a location proximate to electronics so that heat generated by the electronics may be dissipated through the perforations so that the electronics do not overheat. As shown, the perforations are in the rear of the case 14 behind where the battery is located as shown in FIG. 1J.

Next, the system 10 is configured to address lighting issues. Because this system 10 can be used in high lighting (bright) and/or low lighting (dark) environments, the system 10 is configured to compensate and/or adjust accordingly. Indeed, lighting is a factor in the registration and the recall for item camera vision recognition. The system 10 is configured to create controlled lighting conditions. To do this, the system 10 is configured to collect location coordinates, such as GPS coordinates via an onboard GPS module for example, time of day, the date (i.e., time of year), the weather and other environmental conditions, according to some embodiments. The weather and environmental conditions could be determined using the GPS coordinates or could be determined at the location of the system 10 using on-board sensors. The forecast of weather (whether it be rain, overcast, temperature, etc.) can be used so that the SCO system 10 will automatically control itself to protect the SCO terminal 12 housed in the case 14. For example, the system 10 may automatically close if the system 10 predicts or receives information that rain is in the area or if the system detects via sensors raindrops or other weather conditions happening at the system 10.

Moreover, if the system 10 determines that there are dark conditions, such as because it is nighttime or an overcast weather condition, the halo 26 of the SCO 12 will shine a light on the products on the SCO 12 or could use an infrared camera or the like, according to some embodiments. In one embodiment, the SCO 12 could measure the light at the SCO 12 itself using a light detector sensor and determine the light is not bright enough. In this regard, the system 10 could be employed with light sources at various locations within the system 10 and be activated in response to certain triggers (e.g., time of day, time of year, weather, light detection being sensed to be too low, etc.) being activated.

If the system 10 determines that there are too bright conditions, such as because it is a fully sunny day during the summer or external lights (vehicle headlights, security lights, city lights, etc.) are too bright, the SCO 12 can adjust the camera’s sensitivity accordingly, switch to a different camera (e.g., an IR camera), or the like. In one embodiment, in bright conditions, the cover 14 can automatically extend until the brightness level has reduced below a threshold or can fully enclose the SCO 12 until the SCO self-checkout determinations (e.g., product identification, product weight, etc.) are completed.

In some embodiments, the system 10 could be converted into a self-moving robot or vehicle system so that the system 10 is a self-controlled, automated, moving store. In this regard, the system 10 would drive around by itself to offer customers products, such as drinks/snacks, merchandise, etc., and would stop at a customer it recognizes as interested. In this regard, the system 10 could be employed with separate cameras in the cover 14, in the SCO 12, or otherwise in the system 10 along with object detection sensors. The system 10 would then have components to receive the data from the cameras and object detection sensors to allow the system 10 to drive the system 10 around a predetermined area. The system 10 may use artificial intelligence (AI) to interpret received data (customers, environmental conditions for driving, environmental conditions for protecting the SCO, etc.) to move the system 10 to customers or desired locations as well as to control the case 12 and other components of the system 12 to protect and control operations of the SCO 12. When a customer wants an item, the system 10 would drive itself to the customer, stop and allow the customer to purchase the item. In this regard, the system 10 could be mobile with a screen with a face on it to sell items as a mobile and moving store.

Described above is a stand-alone system 10; however, it is envisioned that one location could have a plurality of systems 10 to create a single store for users to checkout effectively and quickly using the plurality of systems 10.

It should be understood that that the mobile system 10 can be fully functional outside of a brick and mortar building because the mobile system 10 has electrical components, a self-checkout SCO 12, a smart case 14, and connectivity to a network (internet) as well as connectivity to databases and payment systems located remote from the mobile system 10. In this regard, the mobile system 10 is configured to connect a customer to allow the customer to perform a transaction for a product of a store so that the customer can identify the product (via the mobile system 10 scanner), transmit the product ID to a database over a network (using networking electronics on the mobile system 10), perform analyses (using a processor and computer instructions on the mobile system 10), and perform payment processing using the mobile system 10 over the network. This mobile system 10 is configured to have a smart case 14 as explained above which will automatically adjust and/or protect itself from the environment (protection from weather, change lighting for the SCO 12 based on lighting of the environment, protection the SCO 12 from falling objects, wind, etc.). This is done using automatic processing via a processor and/or AI technology based on pre-programmed instructions (or connection to a cloud based service which performs real time processing). The mobile system 10 may have wheels and optionally a motor to move the wheels and shelves for storing products (and for the mobile system 10 to determine which products are selected using sensors in each respective shelf).

Thus, there may be various applications for the mobile kiosk including kiosks for use at concerts, sporting events, sidewalk sales, etc. It could be used as an autonomous robot that rolls or otherwise moves around a casino floor selling snacks to customers.

### II. Components and workings of the SCO

Self-service kiosks can require high buyer engagement, including scanning product barcodes for each product and carefully placing such products onto a platform, e.g., so that the scanned products can be weighed and/or monitored during a checkout transaction. In some instances, a buyer may place an unpurchaseable item onto the platform, which may skew the sensed weight of the items on the platform or otherwise delay the transaction. Moreover, a buyer may place an item near, but not on, the platform, which may also affect the sensed weight of the items and the overall checkout transaction. Leaving these issues unresolved can lead to buyer frustration and may require store personnel to resolve the issue. The skewing of the sensed weight can also potentially lead to scale malfunctions and/or incorrect scale calibrations as well as issues with the barcode scanner.

In at least one example embodiment, a self-checkout system can be equipped with features to illuminate one or more items within a predefined zone. In another example, the self-checkout system includes features that illuminate items on or near a platform of the self-checkout system. The self-checkout system can include a light source, such as a projector or laser, that can be controlled to illuminate one or more of the items placed within the predefined zone based on their identities. A computer vision system of the self-checkout system can include one or more cameras 28 and a computing device.

The cameras 28 can include one on either side of the display and one in the halo 26 looking down. The cameras 28 can capture images of the items on or near the platform within the predefined zone, and these captured images can be used by the computing device to identify the items. For instance, the captured images of the items can be compared to images of known items stored in an image library. In at least one example, known items can include purchasable items (i.e., known items that are available for purchase at the store) or non-purchasable items (i.e., known items that are not available for purchase at the store). Items on or near the platform within the predefined zone can be identified when the captured images of an item match an image of the image library. When the captured images of an item do not match any of the images of the image library, the item can be identified as an unknown item.

Also a biometric sensor/camera may be includes in the halo 26 facing where the user would be standing and could verify that the user is accessing the SCO 12 and/or verify the identity of the user.

As noted above, the light source can be controlled to illuminate one or more of the items placed within the predefined zone based on the identities of the items. As one example, the light source can be controlled to project an illuminated indictor onto a known non-purchasable item, e.g., to suggest to a shopper and/or store personnel that the item be removed from the platform so as not to skew the sensed weight of the items on the platform. The illuminated indicator, or light directed onto the item by the light source, can outline the item or otherwise highlight the item to a shopper or store personnel. As another example, the light source can be controlled to project an illuminated indictor onto an unknown item, e.g., to suggest to a shopper and/or store personnel that the item be removed from the platform and/or that the unknown item should be further investigated by store personnel. As yet another example, the light source can be controlled to project an illuminated indictor onto a known purchasable item that is placed near, but not on, the platform, e.g., to suggest to a shopper and/or store personnel that the item be moved onto the platform so that the sensed weight of the items can be more accurately determined and/or so that the item can be more readily monitored. Accordingly, illuminating certain items within the predefined zone can advantageously facilitate a more frictionless and interactive shopping experience for a buyer and can allow store personnel to more quickly identify issues and resolve problems. Moreover, scale malfunctions, incorrect scale calibrations, and issues with barcode scanners can be eliminated or otherwise reduced, among other benefits.

FIG. 1 illustrates a perspective view of an exemplary self-checkout system 100 according to one or more embodiments of the present disclosure. In one example, the self-checkout system 100 can be a self-service checkout kiosk. For reference, the self-checkout system 100 defines a vertical direction V.

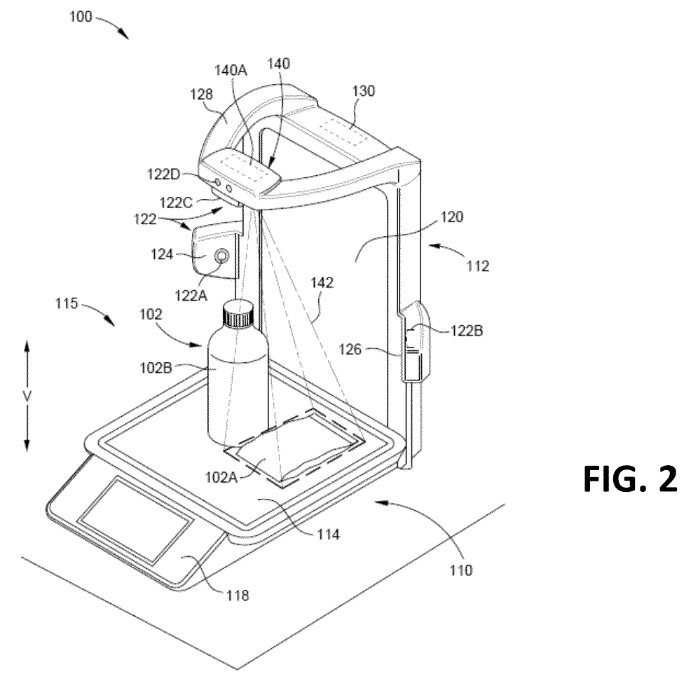

Buyers may select one or multiple items for purchase within a retail store and independently complete a checkout transaction at the self-checkout system 100. The self-checkout system 100 can include a base 110 and a back panel 112. The back panel 112 can be arranged perpendicular with respect to the base 110 as illustrated in FIG. 2. A shopper may place one or more items intended for purchase on a platform 114 of the base 110 during a checkout transaction. The shopper may later remove the items from the platform 114 upon completing or canceling the transaction.

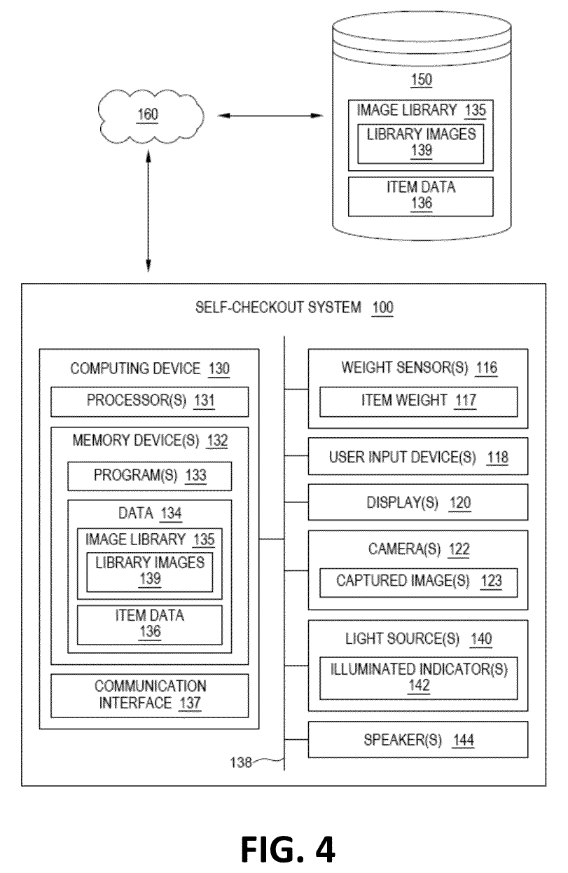

One or more components and/or combinations of components for facilitating a self-checkout transaction can be included in the housing of the base 110 and/or the back panel 112. For instance, the base 110 can include at least one load cell or weight sensor 116 (not shown in FIG. 2; see FIG. 4) positioned under the platform 114. The weight sensor 116 is configured to sense the weight of each and/or all items placed on the platform 114.

The base 110 can include any combination of one or more user input devices 118, for example, a touch screen, keypad, card reader, and/or near-field receiver. The shopper may communicate with the self-checkout system 100 using any of the user input devices 118. For example, the user input device 118 may be a payment mechanism configured to tender payment methods. The back panel 112 can include a display 120 for presenting information to a shopper during the checkout process. For example, the display 120 can present an updated checkout list, checkout instructions, and/or payment instructions to a shopper during a checkout transaction.

Further, the self-checkout system 100 can include one or more cameras 122 to capture respective viewpoints within and/or surrounding a predefined zone 115, or buy zone. For example, the cameras 122 can be configured to capture the items placed on or near the platform 114 and/or a shopper standing in close proximity to the self-checkout system 100. Captured viewpoints of and/or surrounding the predefined zone 115 can include, for example, a left-side viewpoint, a right-side viewpoint, an overhead viewpoint (e.g., angled down towards the platform 114), and/or a forward viewpoint (e.g., angled towards the shopper). The one or more cameras 122 may be attached or detached from the housing of the self-checkout system 100.

As an example, the self-checkout system 100 of FIG. 2 includes a right arm 124 and a left arm 126 each extending from the back panel 112 at opposite sides of the platform 114. Each of the right and left arms 124, 126 can include a camera, e.g., for capturing right and left viewpoint images of the predefined zone 115 or items placed on or near the platform 114, respectively. An item positioned near, but not on, the platform 114 can be captured by the cameras 122 when the item is within a field of view of one or more of the cameras 122. The right arm 124 includes a first camera 122A arranged to capture right side viewpoint images and the left arm 126 includes a second camera 122B arranged to capture left side viewpoint images. Further, the back panel 112 can include a halo 128 that has a third camera 122C arranged to capture overhead viewpoint images of the predefined zone 115 or items placed on or near the platform 114. In addition, the halo 128 can include one or more forward-facing cameras 122D oriented in a forward-facing position, e.g., to capture images of the shopper standing near the self-checkout system 100. The cameras 122 can be configured to capture images based on an indication that one or more items have been detected in the predefined zone 115, or that a shopper has approached within a predetermined proximity of the self-checkout system 100, or based on the weight sensor 116 sensing items on the platform 114, or a combination thereof, or some other trigger condition.

The self-checkout system 100 can also include a computing device 130, which can be arranged in the back panel 112, for example. The computing device 130 can also be arranged in other locations, such as in the base 110 underneath the platform 114. The computing device 130 can be arranged as shown in FIG. 4 and will be described in greater detail further below.

In at least some example embodiments, the computing device 130 and cameras 122 can form part of a computer vision system of the self-checkout system 100. Images captured by the cameras 122, which can be still images or frames of a video, can be routed to the computing device 130 for processing. The computing device 130 can used the captured images to identify the one or more items placed on or near the platform 114. Feedback from the weight sensor 116 can also be fed to the computing device 130 for processing, e.g., in assisting with identification of the one or more items placed on or near the platform 114.

The self-checkout system 100 can also include one or more light sources 140. In at least some example embodiments, the halo 128 can include or support a light source 140A, or overhead light source. The light source 140A can be a projector, a laser, or some other light-emitting device arranged to project light, such as an illuminated indicator 142, onto one or more items 102 placed within the predefined zone 115, or rather, placed on or near the platform 114. In some embodiments, the light source 140A can have a field of illumination greater than the area of the platform 114, e.g., so that items placed near, but not on, the platform 114 can be highlighted by the light source 140A. In this regard, the predefined zone 115 can extend beyond the platform 114. Further, by arranging the light source 140A in or mounted to the halo 128, the light source 140A can be positioned directly above the platform 114 as shown in FIG. 2, which allows the light source 140A to project light from an overhead position onto one or more of the items 102.

The light source 140A can be arranged to project light generally downward toward the platform 114 and onto one or more items based on their identities, as identified by the computing device 130 of the computer vision system. In FIG. 2, for example, based on the determined identity of one of the items 102 placed on the platform 114, the light source 140A can be controlled by the computing device 130 to project an illuminated indicator 142 onto one of the items placed on the platform 114, which in this example is a snack bag 102A. The snack bag 102A can be identified by the computing device 130 as a snack bag that is a known non-purchasable item (i.e., an item that is not purchasable but is known to the computing device 130). Alternatively, the snack bag 102A can be identified as an unknown item (i.e., an item that is not purchasable and unknown to the computing device 130). Consequently, the computing device 130 can control the light source 140A to project the illuminated indicator 142 onto the snack bag 102A to suggest that the snack bag 102A be removed from the platform 114. This can facilitate a more frictionless and interactive shopping experience for the shopper.

The other item on the platform 114 in FIG. 2, which is a bottled water 102B in this example, can also be identified by the computing device 130 based on captured images from the cameras 122. The bottled water 102B can be identified by the computing device 130 as a bottled water that is a known purchasable item (i.e., an item that is purchasable and known to the computing device 130). Accordingly, the light source 140A can be controlled by the computing device 130 not to illuminate the bottled water 102B with an illuminated indicator.

In at least some other embodiments, in addition or alternatively to the light source 140A arranged in the halo 128, the self-checkout system 100 can include one or more light sources positioned in other locations. One example is provided below.

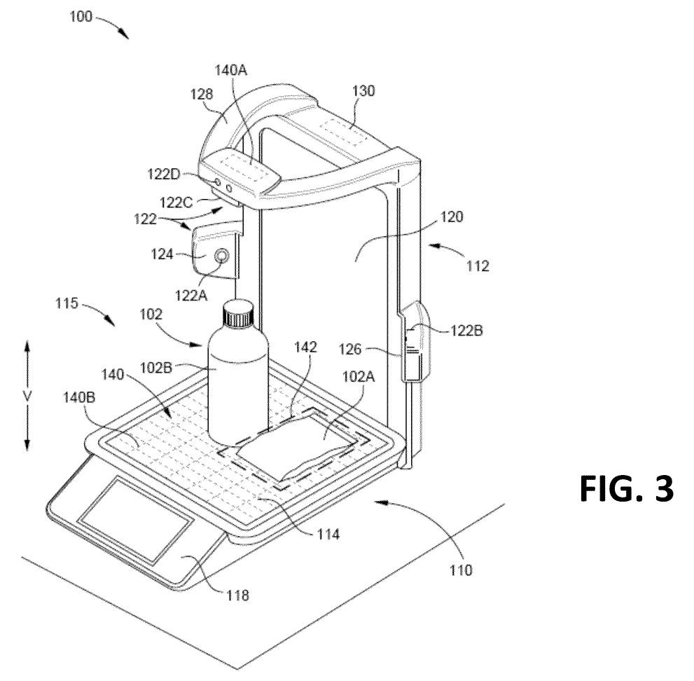

FIG. 3 shows an embodiment of the self-checkout system 100 having a light source 140B that can be arranged underneath, or embedded in, the platform 114. The platform 114 can be at least somewhat translucent so that light emitted by light-emitting devices of the light source 140B can travel through the platform 114, or a top translucent layer thereof, and onto an item placed on the platform 114. The light-emitting devices of the light source 140B can be arranged in an array, e.g., in a grid, and the light-emitting devices can be selectively controlled by the computing device 130 to illuminate one or more items 102 placed on the platform 114, e.g., based on the identities of the items 102. In FIG. 3, the snack bag 102A is shown illuminated by an illuminated indicator 142 projected by the light source 140B, while the bottled water 102B is not.

Accordingly, in some example embodiments, the self-checkout system 100 of FIGS. 1 and/or 2 may be an all-in-one, frictionless, self-service unit that uses computer vision, and in some embodiments sensed item weight, for item identification, and based on the identities of the items 102 placed on or near the platform 114, one or more light sources 140 can be controlled to highlight certain ones of the items 102. By using computer vision and one or more light sources 140 to illuminate certain items, shoppers can be provided with an interactive and intuitive self-checkout experience. Moreover, illuminated items can allow store personnel to more quickly identified issues and resolve problems.

FIG. 4 is a schematic representation of the self-checkout system 100. As illustrated in FIG. 4, the computing device 130 can include one or more processors 131 and one or more memory devices 132 storing a program 133, which, when executed by any combination of the one or more processors 131, causes the one or more processors 131 to perform an operation, such as causing illumination of certain items placed on or near the platform 114 (FIG. 2), which as noted above, can facilitate an interactive checkout transaction. The one or more memory devices 132 can also store data 134. The data 134 can include, among other things, an image library 135 and item data 136. The image library 135 can include images of known items from one or more viewpoints. Known items can include known purchasable items (e.g., chips, bottled water, bananas, etc. available for purchase in a retail store) and known non-purchasable items (keys, smartphones, purses, etc. that are not available for purchase within the retail store, but are known to the computing device 130). In some instances, known non-purchasable items can be inadvertently placed on the platform 114 (FIG. 2), which may affect the weight calculation of items placed on the platform 114. As will be explained further herein, it may be desirable to illuminate such an item to suggest to a shopper that the item be removed from the platform 114. The item data 136 can include data relating to the dimensions, weight, and packaging associated with the known items in the image library 135.

In some embodiments, the image library 135 and the item data 136 can be stored locally on the computing device 130, e.g., in one or more memory devices 132 thereof. In other embodiments, the image library 135 and/or the item data 136 can be stored offboard the self-checkout system 100, e.g., on a data store 150 as shown in FIG. 4. The computing device 130 can access the image library 135 and/or the item data 136 over a network 160, such as the internet. The computing device 130 can include a communication interface 137 that enables communication with over devices over the network 160 and also locally with other devices of the self-checkout system 100 via a communication bus 138. The communication interface 137 can include transmitter circuitry configured to send communication signals and receiver circuitry configured to receive communication signals. In this regard, the communication interface 137 can include transmitters, receivers, transceivers, etc. for communication over the network 160 and/or the communication bus 138. In yet other embodiments, the image library 135 and/or the item data 136 can be stored in part locally and in part remotely.

The computing device 130 is communicatively coupled with other devices/components of the self-checkout system 100 by way the communication bus 138, e.g., by one or more wired and/or wireless communication links. As depicted in FIG. 4, the computing device 130 can be communicatively coupled with the weight sensor 116, the user input device 118, the display 120, the cameras 122, and the light source 140 (or light sources). In at least some embodiments, the computing device 130 is communicatively coupled with one or more speakers 144 of the self-checkout system 100. In at least some embodiments, the display 120 and/or the speakers 144 can be controlled to provide instructions or an alert to a shopper or store personnel in addition to the light sources 140 being controlled to illuminate one or more items placed on or near the platform 114 (FIG. 2).

With reference now to FIGS. 1 and 3, an example manner in which the self-checkout system 100 can illuminate certain items on or near the platform 114 during a checkout transaction will now be provided. In at least one embodiment, when one of the programs 133 is executed by the one or more processors 131, the one or more processors 131 can be caused to, individually or collectively, perform an operation, including the smart illumination operation described below.

The one or more processors 131 can trigger the cameras 122 to capture images of the items 102 placed on or near the platform 114, or rather, the items 102 within the predefined zone 115. For instance, once a shopper has completed gathering items for purchase within a store, the shopper can approach the self-checkout system 100 to perform a checkout transaction. The cameras 122 can be configured to capture images of the predefined zone 115 based on one or more trigger conditions, such as an indication that one or more items 102 have been detected in the predefined zone 115, or that a shopper has approached within a predetermined proximity of the self-checkout system 100, or based on the weight sensor 116 sensing items on the platform 114, or a combination thereof. The cameras 122 can continuously capture images of the predefined zone 115 for a duration of the checkout transaction, for example. In at least some embodiments, the first camera 122A, the second camera 122B, and the third camera 122C can capture images of the items 102 on or near the platform 114 from their respective viewpoints, i.e., right-side, left-side, and overhead viewpoints. Further, in at least some embodiments, the weight sensors 116 can capture the item weight 117 of the items 102 placed on the platform 114.

The one or more processors 131 can receive the images of the one or more items 102 placed on or near the platform 114, or rather, captured images 123. The captured images 123 of the items 102 can be routed to the computing device 130 for processing. Further, the item weight 117 of the items 102 sensed by the weight sensors 116 can be provided to the computing device 130 for processing.

The one or more processors 131 can determine an identity of the one or more items 102 placed on or near the platform 114, based at least in part on the one or more images captured by the one or more cameras 122, or rather, the captured images 123. For instance, in at least some embodiments, the computing device 130 can utilize the captured images 123 to determine the dimensions of the items 102 placed on or near the platform 114. The images of the items 102 captured from multiple viewpoints can facilitate determination of the dimensions of the items 102. The captured images 123 can also be utilized by the computing device 130 to determine the packaging of the items 102. The color scheme, brand name, logos, etc. of the packaging of the items 102 can be considered, for example. Further, in some embodiments, in addition to the captured images 123, the item weight 117 of the items 102 can be received by the computing device 130 and utilized to determine a weight of the items 102 placed on the platform 114, as a total weight or individually. Any suitable technique can be used to determine the individual weights of the items 102 placed on the platform 114.

In at least some embodiments, with the dimensions and weight of the items 102 determined, the one or more processors 131 can access the image library 135 and the item data 136, and one or more subsets of a plurality of library images 139 can be selected to be used for comparison purposes, based on the determined dimensions and weight of the items 102. For instance, based on the dimensions and weight determined for a first item on the platform 114 (e.g., the snack bag 102A), a first subset of the library images 139 can be selected. The first subset of the library images 139 can include images of items known to have similar dimensions and weight as the first item based on the item data 136. The images of the first subset can be utilized for comparison purposes with the captured images 123 of the first item. Similarly, based on the dimensions and weight determined for a second item on the platform 114 (e.g., the bottled water 102B), a second subset of the library images 139 can be selected. The second subset can be a different subset than the first subset. The second subset of the library images 139 can include images of items known to have similar dimensions and weight as the second item based on the item data 136. The images of the second subset can be utilized for comparison purposes with the captured images 123 of the second item. By narrowing the library images 139 to those depicting items having similar dimensions and weight to a given item on the platform 114, the processing time for image comparison can be advantageously reduced.

Once the subsets of the library images 139 are selected for respective ones of the items 102 placed on or near the platform 114, the captured images 123 of an item can be compared to the library images 139 of the subset selected for that item. For instance, for the first item on the platform 114 (e.g., the snack bag 102A), the captured images 123 for the first item can be compared to the library images 139 of the first subset. Similarly, for the second item on the platform 114 (e.g., the bottled water 102B), the captured images 123 for the second item can be compared to the library images 139 of the second subset. In at least some embodiments, the packaging of the items 102 (e.g., the color scheme, brand name, logos, etc.) can be utilized for image comparison purposes. The one or more processors 131 can implement an image recognition program to compare the captured images 123 of the items 102 with the library images 139 of known items. When a “match” between the captured images 123 of an item and the library images 139 occurs, the one or more processors 131 can identify that item as, e.g., a known purchasable item or a known non-purchasable item, for example. In other words, when a match occurs, the item can be labeled or classified as a known item, which can either be purchasable or non-purchasable. Stated yet another way, when the captured images 123 of a given item match one or more of the library images 139 of known purchasable items, the identity of the given item can be determined as a known purchasable item. When the captured images 123 of a given item match one or more of the library images 139 of known non-purchasable items, the identity of the given item can be determined as a known non-purchasable item. When no “match” occurs between the captured images 123 of an item and the library images 139, the one or more processors 131 can identify that item as an unknown item.

In some other embodiments, the one or more processors 131 can determine an identity of the one or more items 102 placed on or near the platform 114 by comparing the captured images 123 of a given item to the plurality of library images 139 of the image library 135, and not a subset thereof. In yet other embodiments, the one or more processors 131 can determine an identity of the one or more items 102 placed on or near the platform 114 by comparing the captured images 123 of a given item to a subset of the plurality of library images 139, with the subset being determined based on the dimensions of the given item (and not its weight), the packaging of the given item (and neither its weight nor its dimensions), or a combination of the dimensions and packaging of the given item (and not its weight).

As one example, the one or more processors 131 can, based on comparing the captured images 123 of the snack bag 102A with the library images 139, identify the snack bag 102A as a known non-purchasable item, or rather, a snack bag that is known to the computing device 130, but not available for purchase. As another example, the one or more processors 131 can, based on comparing the captured images 123 of the bottled water 102B with the library images 139, identify the bottled water 102B as a known purchasable item, or rather, a bottled water that is available for purchase.

Based on the determined identities of the items 102, the one or more processors 131 can cause the light source 140A to project the illuminated indicator 142 onto at least one of the items 102 placed on or near the platform 114. Continuing with the example above, with the snack bag 102A being identified as a known non-purchasable item (i.e., an item known to the computing device 130 but not available for purchase), the one or more processors 131 can command the light source 140A to project the illuminated indicator 142 onto the snack bag 102A, e.g., as shown in FIG. 2. Illuminating the snack bag 102A can alert a shopper or store personnel, e.g., that the snack bag 102A is not available for purchase and should be removed from the platform 114. In at least some embodiments, as depicted in FIG. 2, the illuminated indicator 142 can outline the item to be illuminated, which in this example is the snack bag 102A.

In other embodiments, the illuminated indicator 142 can be projected onto an item with a certain shape, letter, number, some combination thereof, etc., based at least in part on the determined identity of an item. As one example, the illuminated indicator 142 can be projected by the light source 140A onto an item as a question mark, or “?”, e.g., when an item is identified as an unknown item. As another example, the illuminated indicator 142 can be projected by the light source 140A onto an item as the letter X, or “X”, e.g., when an item is identified as being a known non-purchasable item.

A method is provided of illuminating one or more items within a predefined zone of the mobile checkout kiosk self-checkout system according to one or more embodiments of the present disclosure.

First, the mobile checkout kiosk self-checkout system 10 is moved from a first location to a second location. This movement can cause vibrations/shocks to various components. As such, the mobile checkout kiosk self-checkout system 10 will determine if any of the components need adjustment using a self-diagnosis module. If so, the mobile checkout kiosk self-checkout system 10 may send a message over a network indicating that service is needed or may automatically perform corrective action depending on the issue, as explained above.

Second, when the mobile checkout kiosk self-checkout system 10 is at the intended location, the mobile checkout kiosk self-checkout system 10 is set up which may include connecting the device to remote connectivity such as activating and/or setting cellular or wifi service to connect the mobile checkout kiosk self-checkout system 10 to a network.

At this point, a portion of the cover 14 of the mobile checkout kiosk self-checkout system 10 is removed so that the SCO 12 and shelves 20 are accessible to the user. The shelves 20 may be prepopulated with items for sale or, if not, the items may then be placed on the shelves 20 and identified to the mobile checkout kiosk self-checkout system 10 as items for sale.

Further, the electronics of the mobile checkout kiosk self-checkout system 10 are activated using the battery 16 and the mobile checkout kiosk self-checkout system 10 is activated for use.

Next, users can use the SCO 12, which first can include capturing, using one or more cameras, one or more images of one or more items placed within a predefined zone of a self-checkout system on or near a platform of the self-checkout system. For instance, the self-checkout system can include at least three (3) cameras, with at least one of these cameras being at a different height than the others. The cameras can capture images of the items on or near the platform.

As mentioned above, the mobile checkout kiosk self-checkout system 10 can determine and compensate for environmental conditions, such as weather conditions, lighting, etc.

Next, an identity of the one or more items placed within the predefined zone on or near the platform is determined based at least in part on the one or more images captured by the one or more cameras. For instance, the cameras and a computing device can form a computer vision system of the mobile checkout kiosk self-checkout system 10. The computing device can be used to implement an image analysis technique to determine, for example, the shape, dimension, weight, and/or location of one or more items placed in and/or in close proximity to the platform. The determined shape, dimension, weight, and/or location, of one or more items, may be used to identify one or more of the items.

Next, the mobile checkout kiosk self-checkout system 10 will access the amount that the selected item costs by determining this information over the connected network or locally at the mobile checkout kiosk self-checkout system 10. Once the amount is determined, the user can pay using a payment mechanism.

The Appendix illustrates various embodiments and features of exemplary mobile checkout kiosk self-checkout systems. For example, there is disclosed that the SCO can be locked down to the cover using a locking mechanism. Additionally, the cover can have perforations to provide airflow to components like the battery or the SCO which may assist in cooling of these components when needed.

Additionally, one embodiment shows that the mobile checkout kiosk self-checkout systems may just have a frame and not a cover which may be particularly useful where extra airflow may be helpful, to make the mobile checkout kiosk self-checkout system lighter/more mobile, or for other situations,

Moreover, the cover may be used to display branding, placing kiosk numbering or lighting indicating the kiosk is open and available for the next customer, etc.

### III. Mobile Autonomous Interactive Checkout Kiosk with Shopper Detection and Queue-Bypass Logic

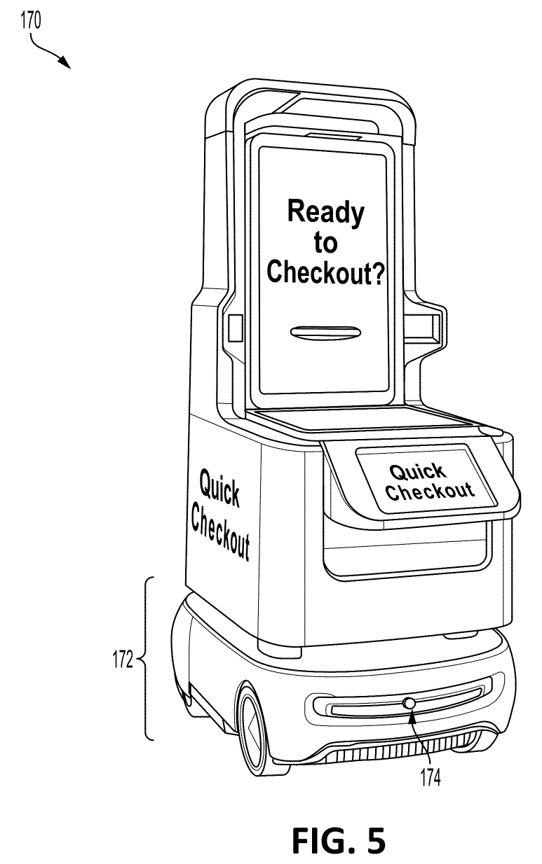

Other embodiments are shown in FIGS. 5-9 which is directed to a Mobile Autonomous Interactive Checkout Kiosk 170/180 with Shopper Detection and Queue-Bypass Logic (“mobile checkout kiosk”).

As background, traditional fixed checkout lanes and static SCO terminals often result in long lines, especially during peak hours. Shoppers with just a few items are often forced to wait behind full-basket customers, resulting in poor throughput and dissatisfaction.

Mobile robots in retail are typically limited to inventory or delivery functions. No existing system combines: mobile checkout hardware, onboard shopper behavior analysis, and voice-driven engagement and guidance. Retailers lack a solution that provides dynamic checkout activation, guided by real-time understanding of shopper context — including the basket size, the proximity to line queues, and the willingness to engage with shoppers.

Generally, to solve the above deficiencies of previous systems, the mobile checkout kiosk of the present disclosure may be a fully autonomous, AI-powered mobile checkout kiosk, according to some embodiments. It uses embedded cameras, computer vision, and edge AI to detect shoppers with a predetermined criteria (e.g., small baskets or few items) and invites them to bypass checkout lines through a voice-driven, frictionless interaction. It combines one or more of the following: an autonomous robotic base (e.g. muse), a self-checkout system such as the self-checkout system 100 (shown in FIGS. 2-3 and described above with regard to FIGS. 2-3), edge-based computer vision (“CV”)/machine learning (“ML”) models for item and shopper classification, a voice interaction engine for hands-free operation, on-device checkout including scanning and payment, etc.

Shoppers are guided entirely through spoken prompts and optional touch, from engagement to transaction completion.

### 1. Hardware/Software Components

There are various hardware components to the mobile checkout kiosk system 170/180, such as those shown in FIGS. 1, 4 and 7. First, the mobile checkout kiosk system 170/180 of FIGS. 5-9 include the features shown and described above with regard to FIGS. 1 and 4. For example, the mobile checkout kiosk system 170/180 includes the features of the SCO system 100 (e.g., screen, cameras, payment mechanism, interface, etc.) as well as the mobility features of FIG. 1, including wheels, cover, battery (or other power source), etc. as well.

In this regard, the mobile checkout kiosk system 170/180 including: a mobile base that includes an autonomous robot (e.g. Muse), equipped with LiDAR and a camera array for navigation, obstacle avoidance and Simultaneous Localization and Mapping (“SLAM”) navigation, a mounted self-checkout kiosk 100 (including a main touchscreen display, secondary embedded screen for payment confirmation, product placement tray with embedded scanners and lighting, high-fidelity microphone and speaker system, optional top-mounted voice direction indicator LED), and any combination thereof.

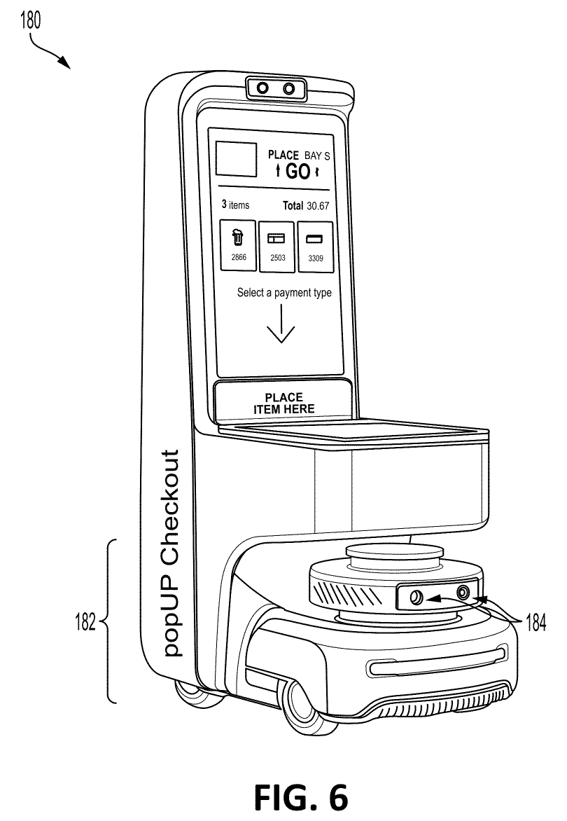

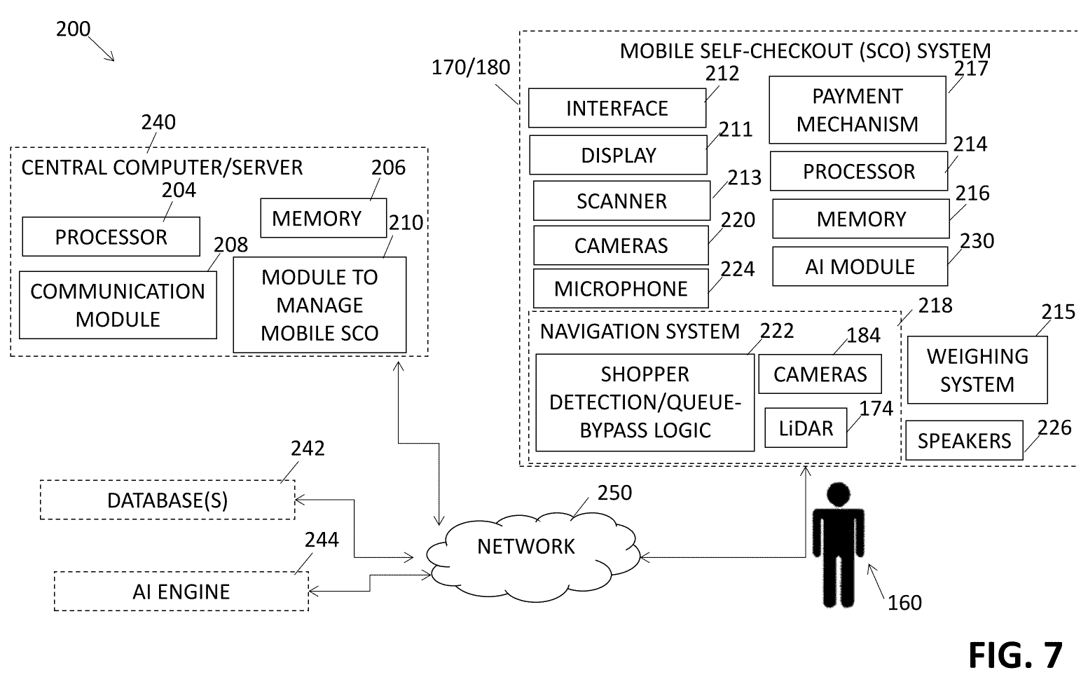

FIG. 7 illustrates a system 200 which can include the SCO 100, the central computer system 240, database(s) 242, AI engine 244, and a network 250. Each of these components are discussed below in connection with the description of FIGS. 5-6.

Generally, in FIG. 2, the mobile self-checkout (“mobile checkout kiosk”) 170/180 includes the scanner 213, display 211, a payment mechanism 217, an interface 212, processor 214, memory 216, a weighing system 215, a navigation system 218, an AI module 230, a microphone 224, checkout cameras 220, and speakers 226. The navigation system 218 includes a module for shopper detection/queue-bypass logic (“shopper detection/queue-bypass logic module”) 222, cameras 184 for navigation, and LiDAR 174 according to some embodiments. As mentioned above, the mobile checkout kiosk 170/180 may be similar to the SCO 100 of FIG. 4. It should be noted that the SCO 100 uses cameras to determine the items for checkout but a scanner may alternatively used or used in addition to the cameras 220. For example, the scanner 213 may be employed and be configured to scan items electronically in order to obtain an item ID that can be used to query the database 242. The display 211 is configured to display items visually on a screen at the SCO 100, including the interfaces 212.

The checkout cameras 220 of the mobile checkout kiosk 170/180 are configured to be a part of the computer vision system of the mobile checkout kiosk system 170/180. The cameras 28 can include one on either side of the display and one at the top of the mobile checkout kiosk 170/180 looking down towards the base. The cameras 220 can capture images of the items on or near the platform within the predefined zone, and these captured images can be used by the mobile checkout kiosk 170/180 to identify the items being presented for checkout. For instance, the captured images of the items can be compared to images of known items stored in an image library. In at least one example, known items can include purchasable items (i.e., known items that are available for purchase at the store) or non-purchasable items (i.e., known items that are not available for purchase at the store). Items on or near the platform within the predefined zone can be identified when the captured images of an item match an image of the image library. When the captured images of an item do not match any of the images of the image library, the item can be identified as an unknown item.

The interfaces 212 are configured to allow the users to input data to the SCO 100 and to display data and messages to the users. The interface 212 may be any software or hardware means to receive input from the user, such as a software graphical user interface (“GUI”) which is configured to allow a user to input data into the fields and also output data to the user. The interface 212 may be interactive to allow the user to interact with the SCO 100 via a touch screen. The interfaces 212 may be stored on the SCO 100 or remotely via the central computer system 240.

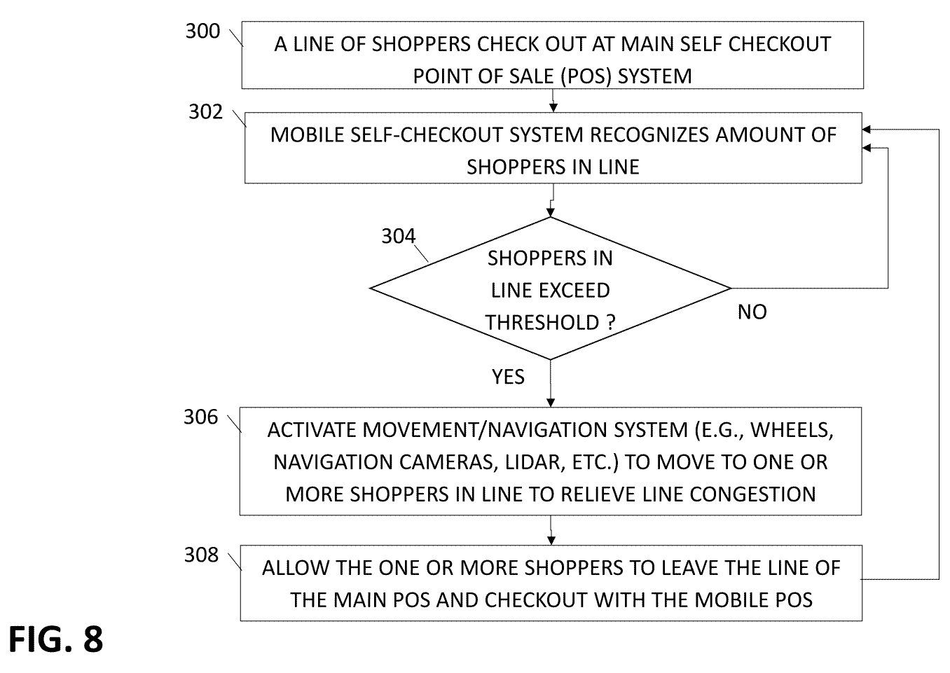

The processor 214 of the mobile checkout kiosk 170/180 is configured to execute computer readable instructions stored in memory 216 to perform one or more method steps discussed in FIG. 8. For example, the processor 204 of the mobile checkout kiosk 170/180 is configured to read and execute instructions from memory 216 for the shopper detection/queue-bypass logic module 222 to perform shopper detection and/or shopper queue-bypass. Each of the steps discussed herein may be programmed to the mobile checkout kiosk 170/180 to perform the specific steps recited herein.

The payment mechanism 217 is a device which is allowed to receive payments from the user which may be cash payments, credit card payments, or any other physical or electronic payments. The payment mechanism 217 may be connected to another network (not shown) which is configured to authenticate and approve the user’s payments, such as an automated clearing house (ACH) network.

The AI module 230 may be a module configured to query the AI engine 244 (or may be an AI engine itself) and to determine/receive commands for execution by the mobile checkout kiosk 170/180. These operations can including calling up and controlling one or more features of the navigation system 218, the processor 214, the memory 216, the interface 212, the microphone 224, speakers 226, and the like. The AI module 230 can make one or more determinations and control feedback back to the mobile checkout kiosk 170/180 based on those determinations, including detecting shoppers and shopping queues as well as determining whether or not to approach one or more shoppers for checkout.

The microphone 224 and speakers 226 may be employed in order to have an oral conversation with the shopper using the AI module 230 so that the interactions with the mobile checkout kiosk 170/180 is as efficient and effective as talking with a human.

The functioning of the SCO components are discussed more in depth with regard to FIG. 8.

As mentioned above, the mobile checkout kiosk 170/180 may be communicatively connected to the central computer system 240. The central computer system 240 includes a processor 204, memory 206, a communication module 208, and a module to manage the mobile checkout kiosk 170/180 210. These components are discussed below.

The processor 204 is configured to execute computer readable instructions stored in memory 206 to perform one or more method steps discussed herein. For example, the processor 204 of the central computer system 240 is configured, via the module to manage the mobile checkout kiosk 170/180, to manage the operations of the mobile checkout kiosk 170/180 including ensuring the software of the mobile checkout kiosk 170/180 is updated, recording data and transactions, ensuring the SCO is running appropriately, etc. It should be noted that any or all of the shopper detection/queue-bypass system 222 may be executed by the central computer system 240 instead of or in conjunction with the mobile checkout kiosk 170/180 and the present disclosure should not be limited to components of the shopper detection/queue-bypass system 222 being run only on the mobile checkout kiosk 170/180, as illustrated in FIG. 7. The central computer system 240 may be any computer or server that is connected to the mobile checkout kiosk 170/180 via a network 250, such as via a LAN or WAN, via a direct wired connection, via a short-range wireless connection, and/or the like.

The communication module 208 of the central computer system 240 is configured to communicate data between the central computer system 240, the database 242, the mobile checkout kiosk 170/180, and the AI engine 244 via the network 250. The communication module 208 is configured to access components on the central computer system 240 in combination with the processor 204 and memory 206.

The database 242 includes various items that the mobile checkout kiosk 170/180 can query including item IDs, weights/images of the items, and prices of the items. These items in the database 242 can be created and updated regularly via the central computer system 240.

The navigation system 218 of the mobile checkout kiosk 170/180 has cameras 184, LiDAR 174 and/or other sensors and electronics that assist in determining the surroundings for navigation purposes as well as to determine shopper’s locations and how many items a shopper has with them in line (e.g., in their cart/basket). The navigation system 218 then uses that information to relieve congestion in shopping lines, in one embodiment.

The navigation system 218 is configured to allow the mobile checkout kiosk 170/180 to detect objects proximate to the mobile checkout kiosk 170/180 as well as a clear path for the mobile checkout kiosk 170/180 to navigate through. This includes detecting objects using a combination of camera vision and LiDAR. LiDAR (Light Detection and Ranging) is a remote sensing technology that uses laser light to measure distances to a target. It works by emitting laser pulses and measuring the time it takes for each pulse to bounce back after hitting an object. These measurements are then used to create highly accurate 3D maps or models of the environment. Once a map of the environment is created, the navigation system 218 operates motors connected to the wheels of the mobile checkout kiosk 170/180 to move the mobile checkout kiosk 170/180 through the mapped environment to a desired location.

In one embodiment, the navigation system 218 is located at a bottom portion 172/182 of the mobile checkout kiosk 170/180, as shown in FIGS. 5-6.

### 2. Shopper Identification and Eligibility

The mobile checkout kiosk 170/180 continuously scans its environment using: cameras (e.g., RGB cameras, depth cameras, etc.), LiDAR-based positioning, and computer vision models. As explained above, the data is shared with the navigation system 218.

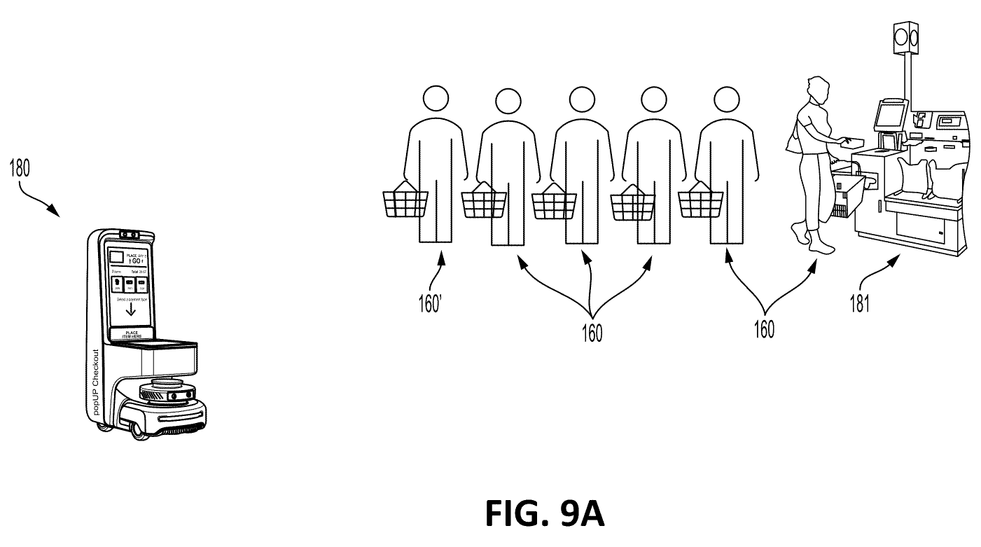

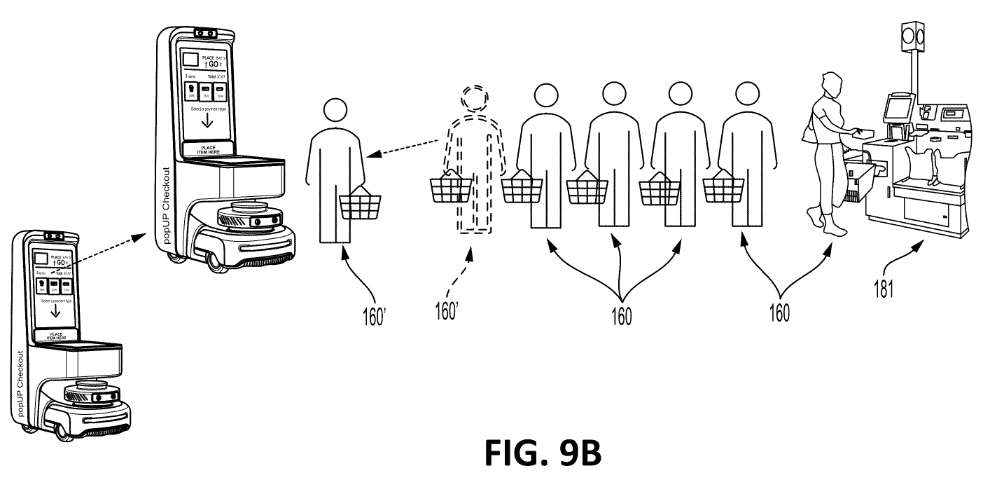

Additionally, using this date, the computer vision models of the shopper detection/queue-bypass logic 222 detect/determine: human presence and motion, the number of items held (based on size, count, or gesture) by each shopper, the proximity of each shopper to checkout lines, and each shopper’s posture and intent (using movement speed, heading, etc.). In this regard, as shown in FIG. 9A, the mobile checkout kiosk 180 detects the shoppers 160/160’ in line at a checkout counter 181 using the cameras 184 and user recognition software in the shopper detection/queue-bypass logic 222 (and optionally the AI module 230).

The shopper detection/queue-bypass logic 222 also determines how many items are in each shopper’s 160 cart/basket. The shopper detection/queue-bypass logic 222 and/or AI module 230 determines if the shopper is ready to checkout by being in the checkout line, determining the shopper’s posture/intent/direction, and the like.

In some embodiments, the shopper detection/queue-bypass logic 222 will select one or more shoppers 160’ to check out according to predetermined criteria. The predetermined criteria may be: (1) if the shopper has less than a predefined amount of items; (2) the shopper is at the end or beginning of the line; (3) the shopper is headed to add to the line; (4) the shopper is in a line greater than a predefined amount of shoppers; (5) the line has greater than a predetermined amount of items for checkout, calculated by adding all items of all shoppers in the line; or any combination of the above. For example, in the embodiment of (1), the mobile checkout kiosk system classifies certain shoppers as “Fast Checkout Eligible” and thus, could checkout this user quickly and thus, such shopper 160’ would bypass the line reducing the congestion in the line.

### 3. Voice-Based Engagement and Workflow

As shown in FIGS. 9A-9B, once a shopper is detected and classified: (1) the kiosk rotates or positions toward the shopper 160’; (2) a voice prompt can interact with the shopper 160’, such as: “Hi there! I see you’ve only got a few items. Want to skip the line and check out right here?”, (3) The shopper 160’ can respond via natural language or simple voice prompts, such as “Yes, let’s do it”, “No thanks”, etc., (4) upon confirmation, the mobile kiosk 180 responds, such as “Great — please place your items on the tray.” The display screen can mirror these interactions visually in real time as well.

The entire interaction from item placement, confirmation, and payment can be fully voice-driven: “Pay with card” / “Use mobile pay”, “Print receipt” / “Send by email”, “Cancel” / “Help”, etc.

### 4. Checkout Logic

As mentioned above, once the shopper is identified and the mobile kiosk 180 approaches the shopper 160’ and the shopper 160’ agrees to checkout with the mobile kiosk 180, the shopper can then checkout at the mobile kiosk 180 instead of the kiosk 181 that the shopper is in line for. In fact, the shopper 160’ can even do this while the shopper is in line for the other kiosk 181. To checkout the shopper 160’, items are recognized by the scanner tray and/or vision algorithms. The total is calculated and announced. For example, the kiosk could say: “Your total is $7.89. How would you like to pay?” Then, payment proceeds via voice confirmation, touch interaction, or short range wireless systems (e.g., NFC tap). The transaction then concludes with a confirmation, such as the kiosk stating “You’re all set. Thanks for shopping!”

### 5. Queue Bypass Logic

The unit operates along the front edge of traditional checkout queues, dynamically finding and engaging eligible shoppers. It avoids engaging full-basket customers, crowding, or those already mid-checkout, as explained above.

A method of FIG. 8 explains this process. First, in step 300, a line of customers/shoppers 160/160’ are in line to checkout at a POS system 181, as shown in FIG. 9A.

In block 302, the mobile checkout kiosk system 180 recognizes the amount of shoppers in line, and determines if the amount of shoppers is greater than a predetermined threshold (or if other predetermined criteria is met). If not, the method may repeat block 302 for other lines of other kiosks (not shown). However, if the mobile checkout kiosk system 180 determines the amount of shoppers is greater than the predetermined threshold (or if other predetermined criteria is met), the method may continue to block 306.

It should be noted that the predetermined criteria may be the number of shoppers but may also be any other criteria, such as length of time shoppers have been waiting to checkout, the total amount of items in aggregate of all shoppers in line waiting to be checked out, a speed of checkout of the line, a combination thereof, or any other criteria.

In block 306, the mobile checkout kiosk system 180 will select a shopper to check out based on (1) how many items the shopper has, the size of the items, etc.; (2) the line that the shopper is in is long, has a slow speed of checkout, etc. (3) how long the shopper has been waiting to checkout, (4) a gesture of the shopper (the shopper is frustrated, angry, or emotional based on facial expression, words detected, etc.); or (5) any combination thereof. The shopper 160’ is then selected and the mobile checkout kiosk system 180 activates the navigation system to move to the shopper 160’. At this point, the mobile checkout kiosk system 180 allows the shopper 160’ to leave the line for the other kiosk 181 (or stay in the line) and instead checkout at the mobile checkout kiosk system 180, thereby reducing the line at the other kiosk 181.

### III. Mobile Autonomous Interactive Checkout Kiosk with Shopper Detection

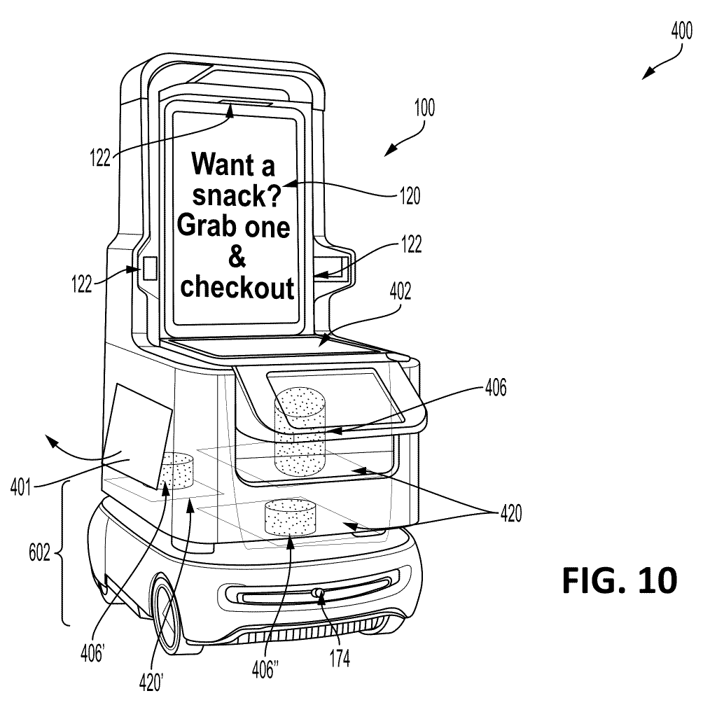

According to another embodiment, FIGS. 10-14 show a variation of the embodiments discussed above and any of the above embodiments can be modified with the features shown in FIGS. 10-14 and discussed below.

FIGS. 10-14 illustrate a mobile SCO 400 having autonomous navigation capabilities and integrated logic therein.

FIGS. 10 and 14 illustrate various components of the mobile SCO 400. The mobile SCO 400 includes the features of the system of FIG. 5 such as a checkout kiosk 100 and a frame but also includes a navigation system 602 and logic to allow a shopper in public, in a store or outside of a store to purchase products on the mobile SCO 400.

As shown in FIG. 10, the mobile SCO 400 also includes a store portion which includes a series of shelves 420 (or compartments), one or more doors 401 (to access the shelves/compartments), etc. which allows a user to select one or more items 406 (which may be located on the shelves 420) for sale. The mobile SCO 400 is configured to navigate to any location inside a store or in any area and the mobile SCO 400 may not be linked to a physical location or store so that a seller may just place the mobile SCO 400 in a general location (e.g., a public area, a park, etc.) so that the mobile SCO 400 is a mobile store that can navigate to potential shoppers in public or other areas, provide items for purchase to the potential shoppers, determine if a shopper has selected an item for sale located on the mobile SCO 400, and allow the shopper to present and to process payment from the shopper.

The mobile SCO 400 has cameras 122 as previously discussed which allows for the kiosk 100 to image the items 406 that are placed on the kiosk platform 402. The kiosk 100 also includes an interface 120 which is configured to interact with the shopper.

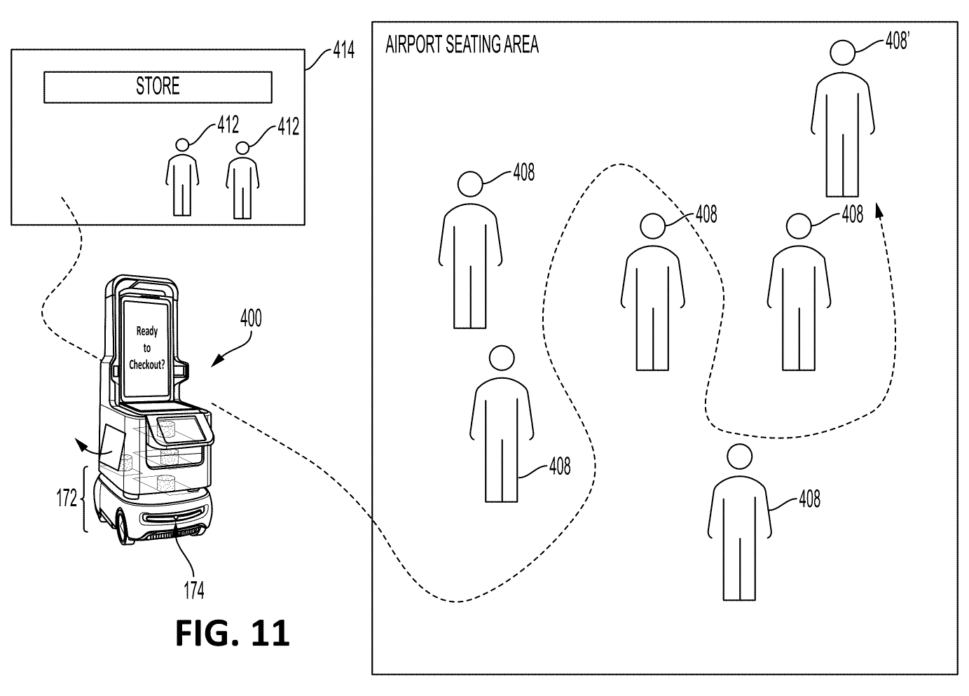

As shown in FIGS. 11-13, a method of operation the mobile self-checkout system of FIG. 10 is shown, according to one or more embodiments of the present disclosure.

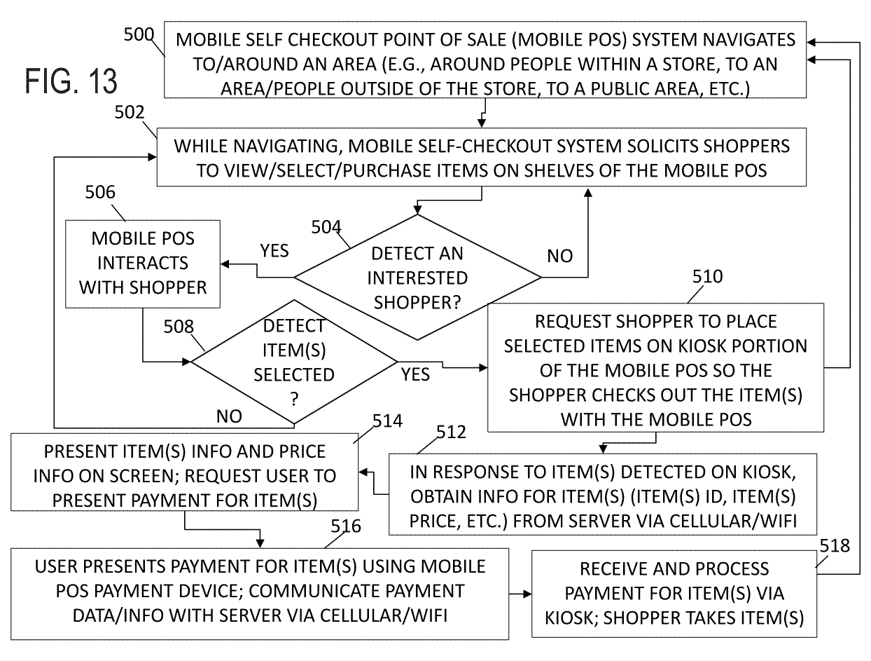

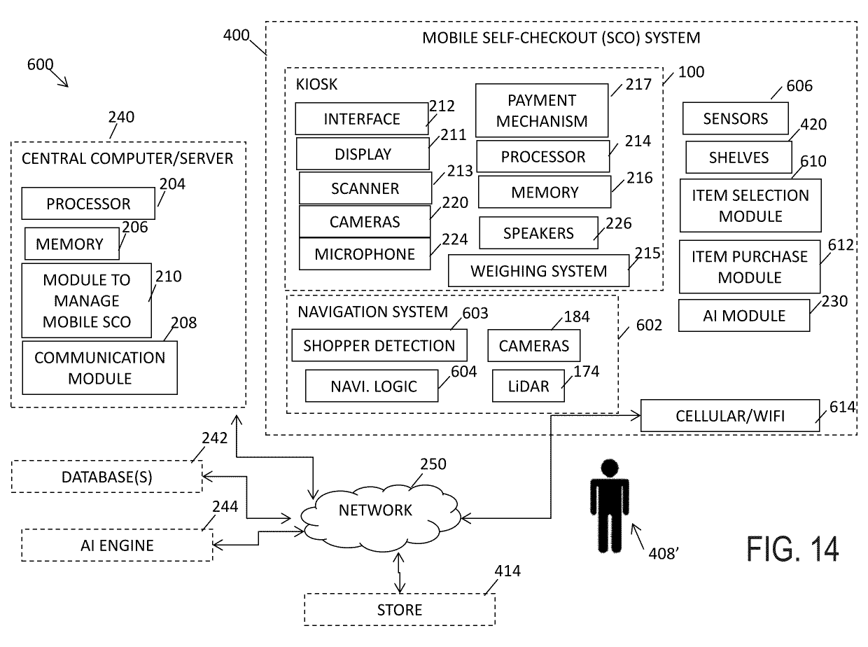

First, as shown in FIG. 11 and in step 500 of FIG. 13, the mobile SCO navigates to/around an area while having items on the mobile SCO 400. Specifically, FIG. 11 illustrates how the mobile SCO 400 can navigate from a store 414 to shoppers 408, including at least one interested shopper 408’. As shown, the shoppers 408 are in an area, such as an airport seating area, in the concourse of a shopping mall, in their seats at a concert, in a public area, in a store, walking on a sidewalk, etc. The mobile SCO 400 is configured to navigate to any of such areas and be a mobile standalone store with items on the mobile SCO 400 that the shopper can select from the mobile SCO 400 and then buy immediately using the mobile SCO 400. The mobile SCO 400 may thus service shoppers 408 outside of stores 414 or shoppers 412 in a store 414. As shown, the mobile SCO 400 in FIG. 11 is a fully stocked mobile store with items 406 on the shelves 420 of the mobile SCO 400.

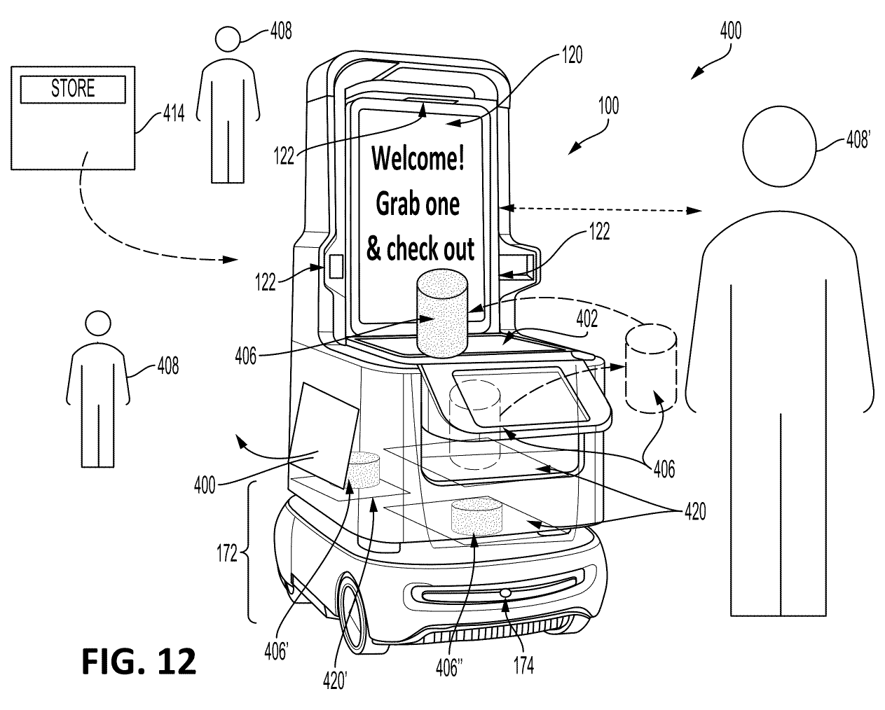

As shown in FIG. 12 and in step 502 of FIG. 13, once the mobile SCO 400 recognizes an interested shopper 408’ the mobile SCO 400 will engage with the shopper 408’ by physically navigating to the interested shopper 408’to so that the shopper can view/shop/purchase items on the mobile SCO 400. To do so, the mobile SCO 400 presents information about the mobile SCO items on the interface 120 of the mobile SCO 400.

At decision block 504, the mobile SCO 400 determines that a shopper is interested or not. This determination can be made in one or several manners, such as if the shopper approaches the mobile SCO 400, the shopper gestures (e.g., waves, etc.) at the mobile SCO 400, the shopper communicates with the mobile SCO 400, uses his mobile device to signal/requests the mobile SCO 400 to approach, or any other method to indicate to the mobile SCO 400 that the shopper is interested. If the mobile SCO 400 determines that a shopper is not interested, the method may continue to navigate to look for interested shoppers at block 502.

If the mobile SCO 400 determines that a shopper 408’ is interested, the method continues to block 506, where the mobile SCO 400 interacts with the shopper 408’.

When the shopper is determined by the mobile SCO 400 to be interested, the mobile SCO 400 navigates to be adjacent to or within an arm’s length of the interested shopper 408’. Then, as shown in block 508, the mobile SCO 400 waits to determine if one or more items on the mobile SCO 400 have been selected. For example, FIG. 12 illustrates that the interested shopper 408’ is grabbing an item 406 from a shelf 420 of the mobile SCO 400, and the mobile SCO 400 knows that the item 406 is selected by receiving a signal from a sensor. For example, each respective shelf 420 has a sensor 606 (FIG. 14) associated therewith and when an item 406 associated with a shelf 420 is removed from that shelf 420, the sensor 606 then is triggered and sends a signal to the mobile SCO 400 indicating that the item 406 associated with the shelf 420 has been removed and thus selected. There are other methods for determining that a shopper 408’ has selected an item 406, such as using cameras 220 to determine if a shopper has removed an item, using item recognition software and the imagery from the cameras, weighing sensors where the weighting sensors detect a change in weight, light/laser sensors where the light/laser detectors indicate that the item no longer blocks the light (or the light/laser beam has been broken), or the like.

After the mobile SCO 400 detects that an item(s) has been selected, the mobile SCO 400 displays that the item 406 is selected and the interface 120 may identify and/or show information (on the screen) relating to the item 406 being removed from the shelf 420. In block 510, the mobile SCO 400 requests the interested shopper 408’ to place the selected item(s) on the kiosk 100 of the mobile SCO 400 so that the shopper 408’ checks out the item(s) with the mobile SCO 400.

In response to the mobile SCO 400 requesting the user to place the selected item on the kiosk platform of the mobile SCO 400, the interested shopper 408’ then places the item 406 on the platform 402 of the mobile SCO 400, as shown in FIG. 12, and the mobile SCO 400 determines the item 406 selected and a price associated with the selected item 406, as shown in block 512. In this regard, the mobile SCO 400 obtains various information/data relating to the selected item(s), including item identification, item price, item description, etc. This information is received over the network 250 via database(s) 242. The network 250 may be a cellular network via a cellular connection from the mobile SCO 400 or via the Internet using a wifi or cellular connection from the mobile SCO 400.

After the item(s) information are obtained, various information (item description, price, etc.) may be presented on the screen and the shopper 408’ is requested to present payment for the selected item(s), as provided in block 514. In block 516, the shopper 408’ presents payment for the selected item(s) to the payment mechanism 217.

In block 518, after the shopper 408’ presents his payment (cash, credit card, etc.) to the payment mechanism 217, the payment is then received and processed by the mobile SCO 400 over the network 250 and the payment is completed, the shopper 408’ then takes the item 406 purchased.

FIG. 14 illustrates the system components to effectuate the above and are similar to FIG. 7 but with additions relating to the mobile SCO 400, including navigating to any area outside stores and allowing a shopper to select and purchase items on the mobile SCO 400.

The system may include the mobile SCO 400, a central computer system 240, database(s) 242, AI engine 244, store 414 and a network 250. Each of these components are discussed below.

Generally, in FIG. 14, the mobile SCO 400 includes the kiosk 100 which includes a scanner 213, a display 211, a payment mechanism 217, an interface 212, processor 214, memory 216, a weighing system 215, a microphone 224, checkout cameras 220, and speakers 226. The mobile SCO 400 also includes shelves 420 (configured to support items for purchase), sensors 606 (associated with the shelves and/or items), a navigation system 602, an AI module 230, a cellular/wifi connection system 614, an item selection module 610 and an item purchase module 612.

The navigation system 602 includes a module for shopper detection logic 603, navigation logic 604, cameras 184 for navigation, and LiDAR 174 according to some embodiments. As mentioned above, the kiosk of mobile SCO 400 may be similar to the SCO kiosk 100 of FIG. 4. It should be noted that the mobile SCO kiosk 100 uses cameras to determine the items for checkout but a scanner may alternatively used or used in addition to the cameras 220. For example, the scanner 213 may be employed and be configured to scan items electronically in order to obtain an item ID that can be used to query the database 242. The display 211 is configured to display items visually on a screen at the SCO 100, including the interfaces 212.

The checkout cameras 220 of the mobile SCO 400 are configured to be a part of the computer vision system of the mobile SCO 400. The cameras 220 can include one on either side of the display and one at the top of the mobile SCO 400 looking down towards the base. The cameras 220 can capture images of the items on or near the platform within the predefined zone, and these captured images can be used by the mobile SCO 400 to identify the items being presented for checkout. For instance, the captured images of the items can be compared to images of known items stored in an image library. Items on or near the platform within the predefined zone can be identified when the captured images of an item match an image of the image library. When the captured images of an item do not match any of the images of the image library, the item can be identified as an unknown item.

The interface 212 is configured to allow the users to input data to the SCO 100 and to display data and messages to the users. The interface 212 may be any software or hardware means to receive input from the user, such as a software graphical user interface (“GUI”) which is configured to allow a user to input data into the fields and also output data to the user. The interface 212 may be interactive to allow the user to interact with the mobile SCO 400 via a touch screen. The interfaces 212 may be stored on the mobile SCO 400 or remotely via the central computer system 240.

The processor 214 is configured to execute computer readable instructions stored in memory 216 to perform one or more method steps or operations discussed in FIGS. 10-13. For example, the processor 214 is configured to read and execute instructions from memory 216 for the shopper detection 203 to perform shopper detection, instructions from memory 216 for the item purchase module 612 to receive and process payment from a shopper, instructions from memory 216 for the item selection module 610 to determine if an item has been selected, and the like. Each of the steps discussed herein may be programmed to the mobile SCO 400 to perform the specific steps recited herein.

The payment mechanism 217 is a device which is allowed to receive payments from the user which may be cash payments, credit card payments, or any other physical or electronic payments. The payment mechanism 217 may be connected to another network (not shown) which is configured to authenticate and approve the user’s payments, such as an automated clearing house (ACH) network.

The AI module 230 may be a module configured to query the AI engine 244 (or may be an AI engine itself) and to determine/receive commands for execution by the mobile SCO 400. These operations can including calling up and controlling one or more features of the navigation system 302, the processor 214, the memory 216, the interface 212, the microphone 224, speakers 226, and the like. The AI module 230 can make one or more determinations and control feedback back to the mobile SCO 400 based on those determinations, including detecting shoppers as well as determining whether or not to approach one or more shoppers for checkout.

The microphone 224 and speakers 226 may be employed in order to have an oral conversation with the shopper using the AI module 230 so that the interactions with the mobile SCO 400 is as efficient and effective as talking with a human.

As mentioned above, the mobile SCO 400 may be communicatively connected to the central computer system 240. The central computer system 240 includes a processor 204, memory 206, a communication module 208, and a module to manage the mobile SCO 210. These components are discussed below.

The processor 204 is configured to execute computer readable instructions stored in memory 206 to perform one or more method steps discussed herein. For example, the processor 204 of the central computer system 240 is configured, via the module to manage the mobile SCO 400, to manage the operations of the mobile SCO 400 including ensuring the software of the mobile SCO 400 is updated, recording data and transactions, ensuring the mobile SCO 400 is running appropriately, etc. It should be noted that any or all of the shopper detection, item selection, or item purchase modules may be executed by the central computer system 240 instead of or in conjunction with the mobile SCO 400 and the present disclosure should not be limited to these components being run only on the mobile SCO 400, as illustrated in FIG. 14. The central computer system 240 may be any computer or server that is connected to the mobile SCO 400 via a network 250, such as via a LAN or WAN, via a direct wired connection, via a short-range wireless connection, and/or the like.

The communication module 208 of the central computer system 240 is configured to communicate data between the central computer system 240, the database 242, the mobile SCO 400, and the AI engine 244 via the network 250. The communication module 208 is configured to access components on the central computer system 240 in combination with the processor 204 and memory 206.

The database 242 includes various items that the mobile SCO 400 can query including item IDs, weights/images of the items, item descriptions, prices of the items, or any other data that is useful for the mobile SCO 400 during navigation or item selection/purchase. These items in the database 242 can be created and updated regularly via the central computer system 240.

The navigation system 602 of the mobile SCO 400 has cameras 184, LiDAR 174 and/or other sensors and electronics that assist in determining the surroundings for navigation purposes as well as to determine shopper’s locations and whether a shopper is interested, as explained above. The navigation system 602 then uses that information to approach the interested shoppers, in one embodiment.

The navigation system 602 is configured to allow the mobile SCO 400 to detect objects proximate to the mobile checkout kiosk 170/180 as well as a clear path for the mobile SCO 400 to navigate through. This includes detecting objects using a combination of camera vision and LiDAR. As explained above, LiDAR (Light Detection and Ranging) is a remote sensing technology that uses laser light to measure distances to a target. It works by emitting laser pulses and measuring the time it takes for each pulse to bounce back after hitting an object. These measurements are then used to create highly accurate 3D maps or models of the environment. Once a map of the environment is created, the navigation system 602 operates motors connected to the wheels of the mobile SCO 400 to move the mobile SCO 400 through the mapped environment to a desired location.

In one embodiment, the navigation system 602 is located at a bottom portion of the mobile SCO 400, similar to area 172/182 shown in FIGS. 5-6.

The descriptions of the various embodiments have been presented for purposes of illustration, but are not intended to be exhaustive or limited to the embodiments disclosed. Instead, any combination of the noted features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to one or more embodiments, other and further embodiments may be devised without departing from the basic scope thereof, and the scope thereof is determined by the claims that follow.

What is claimed is:

1. A mobile self-checkout system comprising:
a frame;
a shopper determination system to select a shopper to approach, where the shopper is proceeding toward or waiting to checkout at a checkout system different from the mobile self-checkout system;
a navigation system comprising motorized wheels and an environment determination system to navigate to the selected shopper; and
a point-of-sale system comprising a processor configured to checkout the selected shopper in response to the mobile self-checkout system navigating to the selected shopper and the selected shopper agreeing to checkout at the mobile self-checkout system.

2. The mobile self-checkout system of claim 1, wherein the environment determination system comprises at least one of a camera and LiDAR.

3. The mobile self-checkout system of claim 1, wherein the shopper determination system selects the shopper based on at least one of:
how many items the shopper has;
a size of the items;
the shopper is in a line that exceed a threshold amount of shoppers;
the line that the shopper is in has a slow speed of checkout;
how long the shopper has been waiting to checkout;
a gesture of the shopper.

4. The mobile self-checkout system of claim 1, wherein the shopper is configured to checkout at the mobile self-checkout system by allowing the mobile self-checkout system to determine the items selected by the shopper for checkout, determine a total price for the selected items, and receive payment of the total price from the shopper for the selected items.

5. The mobile self-checkout system of claim 1, further comprising:
a voice and engagement module to provide voice prompts to the selected shopper to invite the shopper to agree to checkout at the mobile self-checkout system.

6. The mobile self-checkout system of claim 1, wherein the shopper determination system dynamically finds and engages eligible shoppers until lines to other kiosks has reduced below a predetermined threshold.

7. The mobile self-checkout system of claim 1, further comprising the kiosk, the kiosk being configured to be located in a location remote from a building and comprising
one or more cameras; and
a computing device having one or more processors and one or more memory devices storing a program, which, when executed, causes the one or more processors to, individually or collectively, perform an operation, comprising:
receiving one or more images of one or more items within a predefined zone of the self-checkout system, the one or more images being captured by the one or more cameras; and
determining an identity of the one or more items placed within the predefined zone, based at least in part on the one or more images captured by the one or more cameras;.

8. The mobile self-checkout system of claim 1, wherein the shopper determination system avoids selecting shoppers that meet one or more of the following criteria: having an amount of items greater than a predefined threshold and shoppers having an amount of shoppers in front of them that are less than a predefined amount.

9. The mobile self-checkout system of claim 1, wherein the mobile self-checkout system is an autonomous robotic device which employs AI-based computing in selecting a shopper, moving to the shopper and offering to the shopper for checkout.

10. A method for operating a mobile self-checkout system, the method comprising:
selecting a shopper for the mobile self-checkout system to approach, where the shopper is waiting to checkout at a checkout system different from the mobile self-checkout system;
navigating, using a navigation system of the mobile self-checkout system comprising motorized wheels and an environment determination system, to the selected shopper;
requesting the selected shopper to checkout in response to the mobile self-checkout system navigating to the selected shopper and the selected shopper agreeing to checkout at the mobile self-checkout system; and
performing checkout operations for items the selected shopper desires to purchase.

11. The method of claim 10, wherein the environment determination system comprises at least one of a camera and LiDAR.

12. The method of claim 10, wherein the shopper determination system selects the shopper based on at least one of:
how many items the shopper has;
a size of the items;
the shopper is in a line that exceed a threshold amount of shoppers;
the line that the shopper is in has a slow speed of checkout;
how long the shopper has been waiting to checkout;
a gesture of the shopper.

13. The method of claim 10, wherein the shopper is configured to checkout at the mobile self-checkout system by allowing the mobile self-checkout system to determine the items selected by the shopper for checkout, determine a total price for the selected items, and receive payment of the total price from the shopper for the selected items.

14. The method of claim 10, wherein the shopper determination system avoids selecting shoppers that meet one or more of the following criteria: having an amount of items greater than a predefined threshold and shoppers having an amount of shoppers in front of them that are less than a predefined amount.

15. The method of claim 10, wherein the mobile self-checkout system is an autonomous robotic device which employs AI-based computing in selecting a shopper, moving to the shopper and offering to the shopper for checkout.

16. A non-transitory computer readable medium, when executed by a processor, configured for implementing a method for operating a mobile self-checkout system, the method comprising:
selecting a shopper for the mobile self-checkout system to approach, where the shopper is waiting to checkout at a checkout system different from the mobile self-checkout system;
navigating, using a navigation system of the mobile self-checkout system comprising motorized wheels and an environment determination system, to the selected shopper;
requesting the selected shopper to checkout in response to the mobile self-checkout system navigating to the selected shopper and the selected shopper agreeing to checkout at the mobile self-checkout system; and
performing checkout operations for items the selected shopper desires to purchase.

17. The non-transitory computer readable medium of claim 16, wherein the environment determination system comprises at least one of a camera and LiDAR.

18. The non-transitory computer readable medium of claim 16, wherein the shopper determination system selects the shopper based on at least one of:
how many items the shopper has;
a size of the items;
the shopper is in a line that exceed a threshold amount of shoppers;
the line that the shopper is in has a slow speed of checkout;
how long the shopper has been waiting to checkout;
a gesture of the shopper.

19. The non-transitory computer readable medium of claim 18, wherein the shopper is configured to checkout at the mobile self-checkout system by allowing the mobile self-checkout system to determine the items selected by the shopper for checkout, determine a total price for the selected items, and receive payment of the total price from the shopper for the selected items.

20. The non-transitory computer readable medium of claim 16, wherein the shopper determination system avoids selecting shoppers that meet one or more of the following criteria: having an amount of items greater than a predefined threshold and shoppers having an amount of shoppers in front of them that are less than a predefined amount.
